(19) United States
(12) Patent Application Publication
(10) Pub. No.: US 2024/0294214 A1
(43) Pub. Date: Sep. 5, 2024

(54) MULTI-ENGAGEMENT SECURING SURFACE

(71) Applicant: TailHand Co., Centennial, CO (US)

(72) Inventors: Michael Alvin Ruhs, Centennial, CO (US); Michael Scott Lang, Cornelius, NC (US); Daniel Kroll, Seattle, WA (US); Daniel Schilk, Scottsdale, AZ (US); Suzanne Elaine Ruhs, Centennial, CO (US); Chad Daniel Attlesey, Oronoco, MN (US)

(21) Appl. No.: 18/553,472

(22) PCT Filed: Apr. 1, 2022
(86) PCT No.: PCT/US2022/023097

§ 371 Date: Sep. 29, 2023

Related U.S. Application Data
(60) Provisional application No. 63/170,369, filed on Apr. 2, 2021.

(51) Int. Cl. B62D 33/027; B25H 1/04; B25H 1/08

(52) U.S. Cl. CPC B62D 33/0273; B25H 1/04; B25H 1/08

(57) ABSTRACT

Systems and methods are disclosed for a securing surface including a plurality of through-holes and a plurality of receiving channels for securing one or more tools to the securing surface. The securing surface may include a first securing surface and a second securing surface that may be offset from one another. The first securing surface may include a protrusion receiving area for receiving a protrusion in a tool shaft that is designed to enter the through-hole and restrain the tool against the securing surface. The receiving channels may also be designed to engage with a shaft of a tool such that the tool may only move linearly along the securing channel. The securing surface may be secured to a vehicle such as a truck. For example, the securing surface may be secured to the tailgate of a truck.

### TECHNICAL FIELD

The present disclosure relates generally to methods and systems for securing surface and securing tools that engage with the securing surface and more particularly to securing surface to be secured to a vehicle.

### BACKGROUND

Individuals often must travel to jobsites to perform certain tasks involving one or more tools at the job site. For example, a plumber may travel to a residence to fix a broken pipe and it may be desirable to fix the broken pipe or a component thereof at the individual's vehicle. In one example, the individual may carry tools in their vehicle and may even have a portion of their vehicle (e.g., a flatbed) that is used to fix the broken pipe and/or related component. Many jobs require securing an item (e.g., broken pipe) to the vehicle to safely and effectively fix the item. However, well-known securing items that may be used in a garage or workshop may fit awkwardly into the vehicle work space and/or may take up a significant amount of room. For example, a vice is a well-known securing tool but a vice may be difficult to secure to a vehicle and may fit awkwardly into the limited space of the vehicle.

It also may be desirable to secure multiple tools and or items to a vehicle. For example, a long pipe may need to be fixed at both ends. Traditional tools such as a vice may have difficulty securing such items. Further, it may not be feasible to include multiple securing tools into the limited workspace of a vehicle. As vehicles are by nature dynamic and experience a significant amount of vibration, tools that may be commonly used for securing items in a stationary workshop or workspace may deteriorate or may have comprised structural integrity if they are affixed to a vehicle.

It further may be desirable to secure one or more items to a vehicle for transportation purposes. For example, an individual may desire to transport a propane tank. As a propane tank can be volatile and dangerous if it is permitted to move about a vehicle. It is desirable to secure such a tank to the vehicle during transport. However, it may be difficult to secure awkwardly shaped items such as a propane tank to a vehicle. Further, for individuals who commonly transport objects of various sizes, it may be time consuming to rearrange securing tools to accommodate objects of different sizes.

Therefore, it is desirable to provide systems and methods for securing one or more tools and/or items to a vehicle.

### SUMMARY OF THE INVENTION

The present invention is directed to systems and methods for a multi-engagement securing surface. For example, a multi-engagement securing surface may include a dual layer surface with through-holes and receiving channels. Tools may be designed to extend into the through-holes and engage with the dual layer surface to secure the tool to the securing surface. The receiving channels may extend along the securing surface and may be designed to receive a keyed portion of a tool designed to engage with the receiving channels. The securing surface may further include securement regions for securing the securing surface to a vehicle (e.g., to a tailgate of a truck).

The present invention may include a securing surface including a first surface having a plurality of first through-holes and a plurality of linear guides, each of the plurality of first through-holes having a shaft receiving area designed to receive a shaft extending from the first tool and a protrusion receiving area designed to receive a protrusion extending from the shaft of the first tool. The securing surface may further include a second surface including a plurality of second through-holes. The second surface may be disposed below the first surface and offset from the first surface by a distance. Each of the plurality of second through-holes may be designed to receive the shaft of the first tool and aligned with a respective first-through hole of the plurality of first through-holes. The second surface together with the first surface may be designed to restrict movement of the first tool. The securing surface may further include a plurality of tracks disposed within and secured by the plurality of linear guides. Each of the plurality of tracks may engage a keyed distal region of a shaft of a second tool such that each track of the plurality of tracks restricts movement of the second tool to one direction of freedom along a respective linear guide of the plurality of linear guides. The first surface and the second surface may merge to form a beveled perimeter of the securing surface.

The securing surface may include a securing portion extending from the beveled perimeter and designed to couple the securing surface to a first structure. The first structure may be tailgate of a vehicle and the beveled perimeter may permits the tailgate to transition from an open position to a closed position. The shaft receiving area of each plurality of first through-holes may be oriented 45 degrees from a longitudinal axis of the securing surface. The securing surface may include a left securing surface portion, a right securing surface portion, and a middle securing surface portion, and the left securing surface portion and the right securing surface portion may be coupled to the middle securing surface portion by a hinged connection. The left securing surface portion and right securing surface portion may fold onto the middle securing surface portion.

The securing surface may further include a container designed to transition between a first position directly below the second securing surface and a second position below and at least partially offset from the second securing surface. The securing surface may include a securing portion extending from the beveled perimeter, the securing portion may extend over a native engagement of the tailgate and may securely engage the native engagement of the tailgate. The first surface may include second plurality of linear guides, the second plurality of linear guides may be oriented perpendicular to the plurality of linear guides. The securing surface may further include a core material disposed between the first surface and the second surface.

The present invention may include a system including a first tool having a shaft with a threaded portion at a proximal end of the shaft, a keyed portion at a distal end the shaft, and an intermediate portion between the proximal end and the distal end. The intermediate portion may include a ridge and a protrusion disposed distal to the ridge. The first tool may further include a knob having a threaded passage at a first end and a second end with an opening, the threaded passage may engage with the threaded portion of the shaft. The tool may further include a spring disposed around a portion of the shaft and supported at one end by the ridge of the shaft. The spring may apply a spring force to the second end of the knob as the knob moves along the threaded portion toward the distal end of the shaft. The system may further include a securing surface including a first surface and a second surface. The first surface may have a plurality of first through-holes, with each of the plurality of first through-holes having a shaft receiving area designed to receive the shaft of the first tool and a protrusion receiving area designed to receive the protrusion of the first tool. The second surface may include a plurality of second through-holes. The second surface may be disposed below the first surface and offset from the first surface by a distance. Each of the plurality of second through-holes may be designed to receive the shaft of the first tool. The securing surface may be designed to secure the first tool to the securing surface when the shaft of the first tool is disposed within a first through-hole of the plurality of first through-holes and a second through-hole of the plurality of second through-holes and the protrusion of the first tool is positioned between the first through-hole and the second through-hole and is angularly offset from a first protrusion receiving area of the first through-hole.

The first surface and the second surface may merge to form a beveled perimeter of the securing surface. A securing portion may extend from the beveled perimeter and may couple the securing surface to a first structure. The first structure may be a tailgate of a vehicle and the beveled perimeter may permit the tailgate to transition from an open position to a closed position. The shaft receiving area of each plurality of first through-holes may be oriented 45 degrees from a longitudinal axis of the securing surface. The first tool further includes a handle rigidly coupled to the shaft. The first surface may include a first plurality of linear guides. The first surface may further include a second plurality of guides. The second plurality of linear guides may oriented perpendicular to the first plurality of linear guides. The keyed portion of the shaft of the first tool may include a “T” shape and/or may be sized and shaped to engage one of the first plurality of linear guides. The knob further may include a rubberized contact surface at the second end of the knob.

### BRIEF DESCRIPTION OF THE DRAWINGS

FIG. 1 is a perspective illustration of the securing surface engaged with multiple tools, in accordance with an illustrative embodiment of the present invention.

FIG. 2A is a perspective illustration of the securing surface, in accordance with an illustrative embodiment of the present invention.

FIG. 2B is a perspective illustration of the dual layer structure of the securing surface, in accordance with an illustrative embodiment of the present invention.

FIG. 3A is a perspective illustration of the securing surface assembly, in accordance with an illustrative embodiment of the present invention.

FIG. 3B is a perspective illustration of the securing surface, in accordance with an illustrative embodiment of the present invention.

FIG. 3C is a perspective illustration of the frame, in accordance with an illustrative embodiment of the present invention.

FIG. 3D is a perspective illustration of the securing surface, in accordance with an illustrative embodiment of the present invention.

FIG. 3E is a perspective illustration of the track, in accordance with an illustrative embodiment of the present invention.

FIG. 4A is a perspective illustration of the securing surface secured to an open tailgate of a vehicle, in accordance with an illustrative embodiment of the present invention.

FIG. 4B is a perspective illustration of the securing surface secured to a closed tailgate of a vehicle, in accordance with an illustrative embodiment of the present invention.

FIG. 5A is a perspective illustration of an alternative securing surface, in accordance with an illustrative embodiment of the present invention.

FIG. 5B is a perspective illustration of an alternative securing surface, in accordance with an illustrative embodiment of the present invention.

FIG. 5C is a perspective illustration of an alternative securing surface, in accordance with an illustrative embodiment of the present invention.

FIG. 5D is a perspective illustration of an alternative securing surface, in accordance with an illustrative embodiment of the present invention.

FIG. 5E is a perspective illustration of an alternative securing surface, in accordance with an illustrative embodiment of the present invention.

FIG. 6A is a perspective illustration of an exemplary tool arrangement on a securing surface, in accordance with an illustrative embodiment of the present invention.

FIG. 6B is a perspective illustration of an alternative exemplary tool arrangement on a securing surface, in accordance with an illustrative embodiment of the present invention.

FIG. 7A is a side illustration of a securing tool engaged with the securing surface, in accordance with an illustrative embodiment of the present invention.

FIG. 7B is a cross-sectional illustration of a securing tool engaged with the securing surface, in accordance with an illustrative embodiment of the present invention.

FIG. 8A is a side illustration of a securing tool, in accordance with an illustrative embodiment of the present invention.

FIG. 8B is a cross-sectional illustration of a securing tool, in accordance with an illustrative embodiment of the present invention.

FIG. 9A is a side illustration of a securing tool, in accordance with an illustrative embodiment of the present invention.

FIG. 9B is a cross-sectional illustration of a securing tool, in accordance with an illustrative embodiment of the present invention.

FIG. 9C is a cross-sectional illustration of a securing tool engaged with the securing surface, in accordance with an illustrative embodiment of the present invention.

FIG. 10A is a top-down view of a protrusion receiving area and a protrusion, in accordance with an illustrative embodiment of the present invention.

FIG. 10B is a top-down view of a protrusion receiving area and a protrusion, in accordance with an illustrative embodiment of the present invention.

FIG. 10C is a top-down view of a protrusion receiving area and a protrusion, in accordance with an illustrative embodiment of the present invention.

FIG. 11 is a cross-sectional illustration of a securing tool which may be directly engaged with a securing surface, or secured to a securing surface via one or more tools designed to engage with the securing surface, in accordance with the principles of the present invention.

FIG. 12 is a side illustration of a hand grip which may be directly engaged with a securing surface, or secured to a securing surface via one or more tools designed to engage with the securing surface, in accordance with the principles of the present invention.

FIG. 13 is a side illustration of a securing tool including an extended contact surface, in accordance with an illustrative embodiment of the present invention.

FIG. 14 is a front illustration of a vertical rack which may be directly engaged with a securing surface, or secured to a securing surface via one or more tools designed to engage with the securing surface, in accordance with the principles of the present invention.

FIG. 15 is a side illustration of a light which may be directly engaged with a securing surface, or secured to a securing surface via one or more tools designed to engage with the securing surface, in accordance with the principles of the present invention.

FIG. 16 is a perspective illustration of a bike mount which may be directly engaged with a securing surface, or secured to a securing surface via one or more tools designed to engage with the securing surface, in accordance with the principles of the present invention.

FIG. 17A is a perspective illustration of a vertical camera mount which may be directly engaged with a securing surface, or secured to a securing surface via one or more tools designed to engage with the securing surface, in accordance with the principles of the present invention.

FIG. 17B is a perspective illustration of an angled camera mount which may be directly engaged with a securing surface, or secured to a securing surface via one or more tools designed to engage with the securing surface, in accordance with the principles of the present invention.

FIG. 17C is a perspective illustration of a collapsible camera mount which may be directly engaged with a securing surface, or secured to a securing surface via one or more tools designed to engage with the securing surface, in accordance with the principles of the present invention.

FIG. 18A is a perspective illustration of a camera track mount which may be directly engaged with a securing surface, or secured to a securing surface via one or more tools designed to engage with the securing surface, in accordance with the principles of the present invention.

FIG. 18B is a perspective illustration of an alternative camera track mount which may be directly engaged with a securing surface, or secured to a securing surface via one or more tools designed to engage with the securing surface, in accordance with the principles of the present invention.

FIG. 19 is a perspective illustration of a securing surface secured to a tailgate engagement, in accordance with an illustrative embodiment of the present invention.

FIG. 20 is a perspective view of a securing surface integrated into a tailgate, in accordance with an illustrative embodiment of the present invention.

FIG. 21 is a perspective illustration of a securing surface including a container, in accordance with an illustrative embodiment of the present invention.

FIG. 22A is a perspective illustration of a folding securing surface secured to a tailgate of a vehicle in an unfolded configuration, in accordance with an illustrative embodiment of the present invention.

FIG. 22B is a perspective illustration of a folding securing surface secured to a tailgate of a vehicle in a partially unfolded configuration, in accordance with an illustrative embodiment of the present invention.

FIG. 22C is a perspective illustration of a folding securing surface secured to a tailgate of a vehicle in a folded configuration, in accordance with an illustrative embodiment of the present invention.

FIG. 23 is a perspective illustration of a ramp which may be directly engaged with a securing surface, or secured to a securing surface via one or more tools designed to engage with the securing surface, in accordance with the principles of the present invention.

FIG. 24 is a perspective illustration of a step ladder which may be directly engaged with a securing surface, or secured to a securing surface via one or more tools designed to engage with the securing surface, in accordance with the principles of the present invention.

FIG. 25A is a perspective illustration of a seat which may be directly engaged with a securing surface, or secured to a securing surface via one or more tools designed to engage with the securing surface, in accordance with the principles of the present invention.

FIG. 25B is a perspective illustration of a seat which may be directly engaged with a securing surface secured to a tailgate of a vehicle, or secured to a securing surface secured to a tailgate of a vehicle via one or more tools designed to engage with the securing surface, in accordance with the principles of the present invention.

FIG. 25C is an alternative perspective illustration of a seat which may be directly engaged with a securing surface secured to a tailgate of a vehicle, or secured to a securing surface via one or more tools designed to engage with the securing surface, in accordance with the principles of the present invention.

FIG. 26 is a perspective illustration of a storage locker which may be directly engaged with a securing surface, or secured to a securing surface via one or more tools designed to engage with the securing surface, in accordance with the principles of the present invention.

The foregoing and other features of the present invention will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

A multi-engagement securing surface may include multiple through-holes extending through the securing surface. The securing surface may also include multiple receiving channels designed to engage keyed portion of a securing tool. The securing surface may have beveled edges and may include securing portions along the perimeter of the securing surface. The securing portions may be used to secure the securing surface to a vehicle. In one example, the securing surface may be secured to truck, and specifically to the tailgate of a truck.

The securing surface may include an upper layer and a lower layer, each planar in shape and oriented in parallel with one another. The through-holes in the upper layer may each be aligned with a respective through-hole in the lower layer. The through-hole in the upper layer may include a pin receiving portion designed to permit a pin of a tool to traverse the through-hole. The tool may be rotated in the through-hole to secure the tool to the securing surface.

The securing surface may further include one or more receiving channels incorporated into the securing surface. The tool, engaged with the receiving channel, may move linearly in the channel but may be restrained by the channel from movement in any other direction. The tool may further include a surface engaging portion that may lock the tool into place with respect to the securing surface such that the tool is restrained from movement in all direction. In one example, receiving channel may optionally include threaded engagements which may engage a threaded end of a tool.

The one or more tools may be engaged with the through-holes and/or the receiving channels to secure an item to the securing surface. For example, one more tool may compress a board or pipe against the securing surface to restrain the board or pipe against the securing surface. An individual may work on the secured item and when finished may release the item from the securing surface. Where the securing surface is secured to a vehicle, the securing surface may provide a mobile securing surface for fixing, building, analyzing, and/or adjusting one or more items.

Tools which may engage with the securing surface include, but are not limited to, a chain saw, jigsaw, radial arm saw, chop saw, circular saw, chopping saw, hand saw; router, drill, joinder, sander, chisel, plane, steel square, battery, power generator, hammer, level, vice, clamp, fence, tape measure, knife, drafting equipment, light, bike rack, boat rack, camera mount, camera track mount, step ladder, ramp, chair, storage locker, and the like. Other types of equipment, such as recreational equipment, may also be secured to the securing surface. This list is intended to be exemplary and, as such, does not limit the scope of the disclosure. Tools and/or equipment may be directly engaged with a securing surface via one or more through-holes, receiving channels, and/or threaded engagements. Alternatively, or additionally, tools and/or equipment may be secured to a securing surface via one or more securing tools designed to engage with the securing surface. Tools and/or may engage, directly or via a securing tool, with any of the securing surfaces disclosed herein.

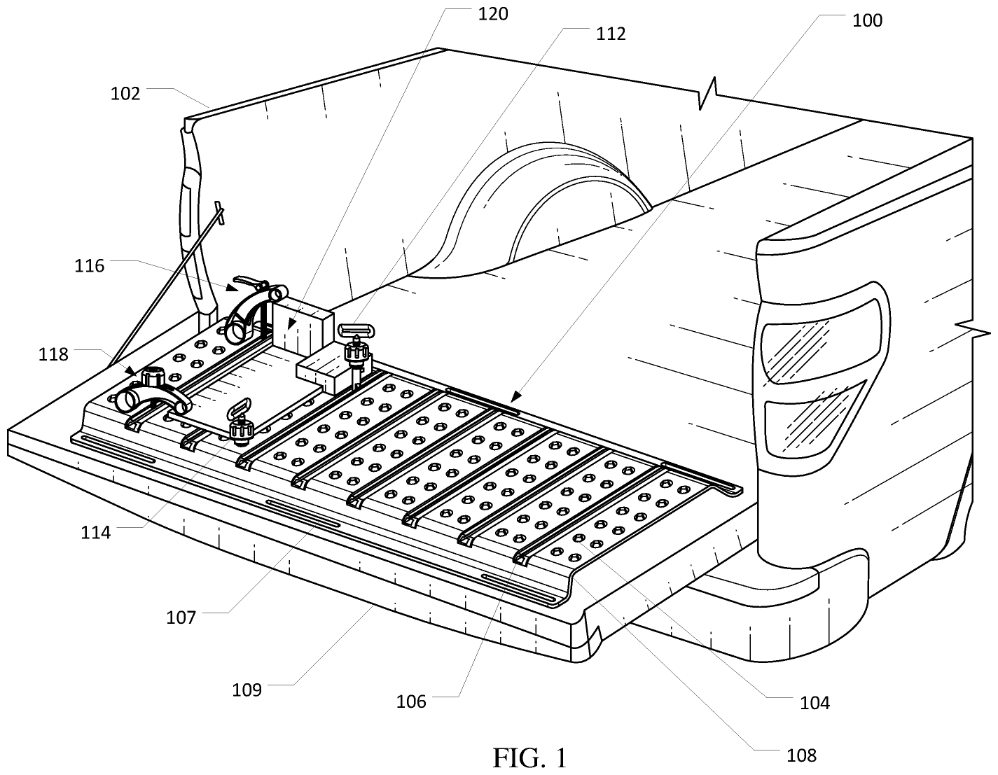

Referring now to FIG. 1, securing surface 100 secured to vehicle 102 is illustrated, in accordance with the principles of the present invention. As is shown in FIG. 1, securing surface 100 may be planar in shape and may include multiple through-holes, such as through-hole 104. Securing surface 100 may further include multiple receiving channels, such as receiving channel 106. Securing surface 100 may be rectangular and may have beveled edges along its perimeter (e.g., beveled edge 108).

Securing surface 100 may further include multiple securing portions 107 along its perimeter. For example, securing portions 107 may include a slot, thread-hole or other well-known securing feature. In one example, securing portion may include a slot designed to receive a bolt to be secured to a vehicle at one end of the bolt. Alternatively, the securing surface could be welded to the vehicle, glued to the vehicle, or otherwise affixed to a surface of the vehicle. As the vehicle will be moving, it is important that the securing portion be affixed to the vehicle in a manner that withstands extreme movement and vibration. For example, the securing surface 100 may be fastened to the tailgate of a truck (e.g., tailgate 109), which may be ergonomic given the typical height of the tail-gate is near waist level of an adult.

Through-holes 104 may extend through all or a portion of securing surface 100 and may be designed to engage and receive a portion of one or more tools. A tool engaged with a through-hole 104 may be restrained from movement in all directions or in all directions except for rotation about the primary axis of the tool. Similarly, receiving channels 106 may be incorporated into the securing surface and may be designed to engage and receive a portion of a tool. For example, a portion of a tool may be designed to fit into receiving channel 106 such that the tool may slide along receiving channel 106 but may not move any other direction.

Securing surface may be one or more layers. For example, securing surface may be a dual-layer structure with an upper layer and a lower layer and gap therebetween. Alternatively, securing surface may be a single layer with a distance between an upper surface and a lower surface that is sufficient to secure a tool via through-hole 104, for example. It is understood that securing surface 100 may be made of any well-known rigid and robust material such as metal (e.g., steel or aluminum) or metal alloy or even hardened and/or heavy-duty plastic. In one example, the securing surface may be made from two different materials (e.g., metal and plastic).

As is shown in FIG. 1, multiple tools may be secured to securing surface 106 to secure one or more items to the securing surface. For example, tools 112, 114, 116, 118 may be engaged with securing surface to secure item 120 to securing surface. Item 120 may be multi-surface piece of wood. Tool 112 may be engaged at a first end with a receiving channel and may engage item 120 at a second end. Tool 114 may engage a through-hole at one end and may engage item 120 at another end.

Tools 116 and 118 may be threaded and may engage a threaded engagement of a receiving channel at one end and may engage item 120 at the other end. In this manner, tools 112, 114, 116 and 118 may each engage item 120 at various heights to secure item 120 to securing surface 100. It is understood that tools designed to engage with the securing surface 100 may be any well-known tool including hooks, clamps, dog-clamps, snap-fit connectors, screws, bolts, and lighting, for example,

While item 120 is illustrated as a multi-faced piece of wood, it is understood that a variety of items with varying shapes and sizes may be secured to securing surface 100. For example, common items such as a propane tank, lumber, an appliance, a television, a barbeque, a pipe, and/or metal plate may be secured to the securing surface using one or more tools. It is further understood, that one or more tools (e.g., power tools, non-power tools, recreational requirement, etc.) or features may be designed to engage with the through holes, receiving channels or threaded engagements.

Tools and/or features such as a chain saw, jigsaw, radial arm saw, table saw, chop saw, circular saw, chopping saw, hand saw, router, drill, joinder, sander, chisel, plane, steel square, battery, power generator, hammer, level, vice, clamp, fence, tape measure, knife, drafting equipment, and the like, may be directly engaged with the securing surface 100 (e.g., via one or more through-holes, receiving channels, and/or threaded engagements) or may be secured to the securing surface 100 via one or more tools designed to engage with the securing surface. Additionally, or alternatively, other types of equipment or items may be secured to securing surface 100, such as recreational equipment (e.g., skis, one end of a hammock, kayak, etc.). For example, skis may be secured to securing surface 100 for transporting the skis.

While FIG. 1 shows a variety of tools that may be engaged with securing surface 100, it is understood that any well-known tools or device may be modified to engage with a through-hole and/or receiving channel of securing surface 100. For example, a tool similar to tool 112 may include a clamp instead of or in addition to handle and may receive a strap in the clamp. Using one or more such tools that are designed to engage with a through-hole and/or receiving channel, the strap may secure and/or wrap around an object and the tool with the clamp may be used to tighten the strap such that the object may be tightly secured to the securing surface. In one example, the securing surface may be secured to a closed tailgate, and the strap may tightly secure a propane tank. In this manner the tool may be a fastening point to the tailgate.

In another example, a tool may be a vertical bracket that may be engaged with securing surface 100 (e.g., via a through-hole) but may extend beyond the perimeter of securing surface 100, such that the tool may elevate and/or extend when the tailgate is the closed position. In one example, the tool may be a clamp or bracket type device and may be designed to secure objects to the vehicle that extend above the tailgate. For example, lumber or a ladder may be placed in a truck bed and may extend over the tailgate in the closed position. The tool that extends upwards may support and/or secure the object (e.g., lumber or ladder) that extends beyond the tailgate.

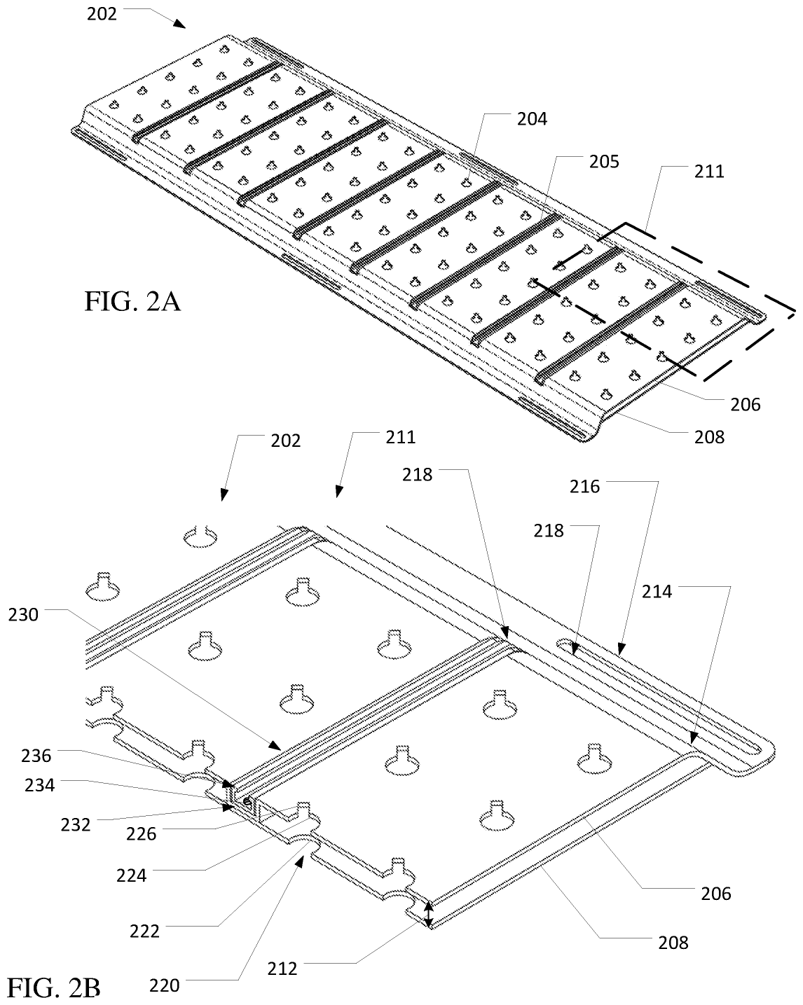

Referring now to FIGS. 2A-2B, securing surface 202 is illustrated, in accordance with the principles of the present invention. FIG. 2A illustrates a perspective view of securing surface 102. As shown in FIG. 2A, securing surface 202 may be dual-layer securing surface having a first securing surface 206 and second securing surface 208. Similar to securing surface 100, securing surface 202 may be planar and rectangular in shape. First securing surface 206 may be parallel to second securing surface 208. Through holes 204 may extend through first securing surface 206 and second securing surface 208. Further receiving channels 205 may be formed into first securing layer 206. As shown in FIG. 2A, multiple receiving channels may be arranged parallel to one another.

Referring now to FIG. 2B, close up view 211 of securing surface 202 of FIG. 2A is illustrated. As shown in FIG. 2B, first securing surface 206 and second securing surface 208 may be positioned distance 212 from one another. It is understood that there may be a vacant void between first securing surface 206 and second securing surface 208. Alternatively, a material (e.g., core) may be disposed between first securing surface 206 and second securing surface 208. It is understood that the first securing surface and the second securing surface may or may not be contiguous. In one example, first securing surface 206 and second securing surface 208 and the core disposed between the first securing surface 206 and second securing surface 208 may be the same material. It is further understood that more than two securing surfaces may be incorporated into securing surface 202 (e.g., three securing surfaces).

First securing surface 206 and second securing surface 208 may come together at a perimeter of securing structure 202 to form beveled edge 214. Beveled edge 214 may extend along two sides of securing surface 202. In one example, beveled edge 214 may permit securing surface 202 to be secured to a tailgate of a vehicle such that the tailgate may open and close without securing surface 202 interring with the open and close functionality of the tailgate of the vehicle.

Beveled edge 214 may extend into securing portion 216 which may extend along the perimeter of securing surface 202. Securing portion 216 may include securing slot 218. Securing slot 218 may be a slot or longitudinal void that extends through securing portion 216 and may receive a threaded bolt or other well-known securing device for securing portion 216 to a vehicle. It is understood that multiple slots 218 may be distributed about the perimeter of the securing surface 202 to facilitate fastening of the securing surface 202 to a vehicle.

As shown in FIG. 2B, securing surface 202 may include multiple through-holes 220, which may include through-hole 224, extending through first securing surface 206, and second through-hole 222, which may extend through second securing surface 208, and may be aligned with second securing surface 208. Through-hole 224 may include protrusion receiving area 226 which may be sized and shaped to receive a protrusion (e.g., pin or lock) extending from a shaft of a tool. Through-hole 220 may be sized and shaped to receive the shaft of the tool. Protrusion receiving area 226 may be oriented at a certain degree (45 degrees) from the longitudinal axis of securing surface 202.

Securing surface 202 may include multiple receiving channels 230. Guide channel 232 (e.g., linear guide) may be formed from and/or defined by first securing surface 206. Track 236 may be inserted into receiving channel 230. In one example, track 236 may be glued otherwise affixed to receiving channel 230. Track 236 and/or receiving channel 230 may include one or more threaded portions 240 to receive and engage a threaded portion of a tool. It is understood that track 236 and receiving channel 230 may be a single component and/or otherwise may be integrated.

Track 236 and receiving channel 230 may be sized to receive a keyed portion of the tool (e.g., a keyed portion extending from the shaft of the tool). Track 236 may be “T” shaped to permit the keyed portion of the tool to enter track 236 from an end of track 236 (e.g., track end 218), and slide linearly along track 236. However, track 236 may restrain movement in any other direction. It is understood that track 236 and/or receiving channel 230 may be any other shape designed to restrain a keyed portion of the tool (e.g., a circular shape).

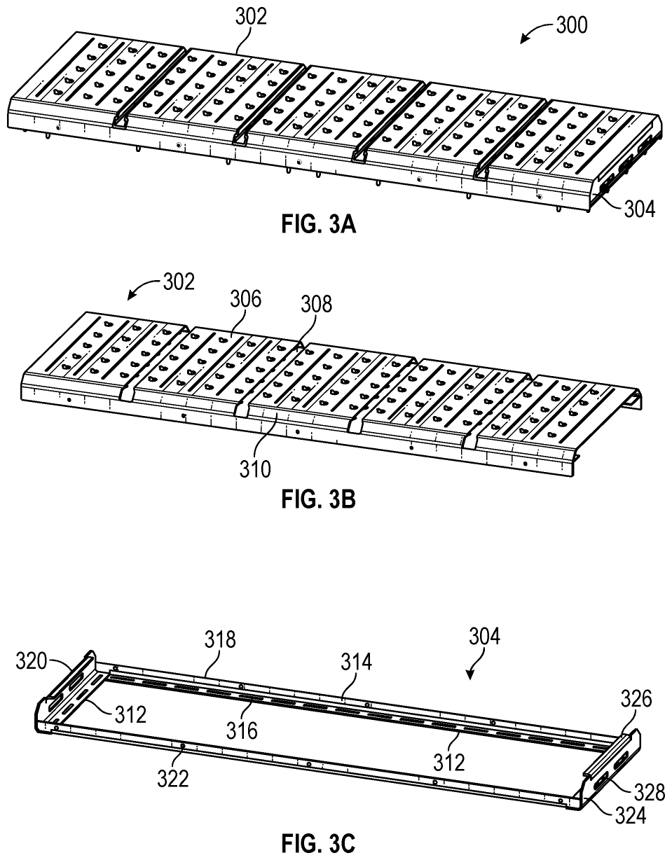

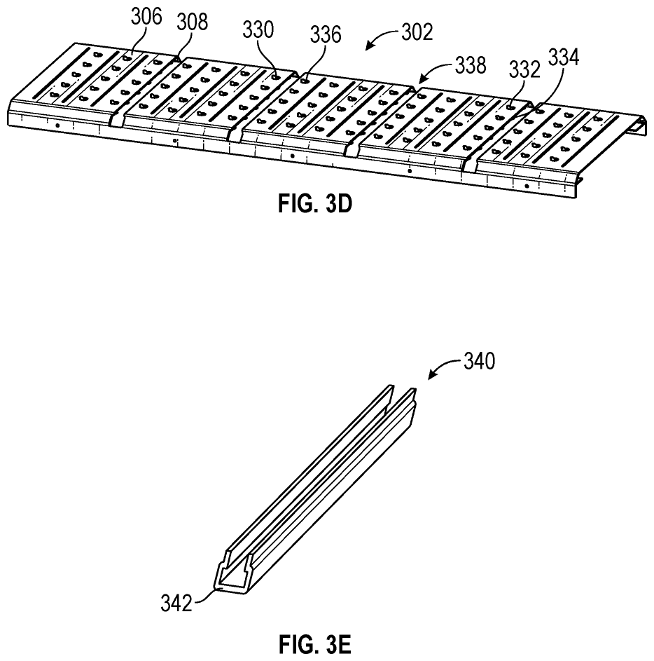

Referring now to FIGS. 3A-3E, assembly 300 including securing surface 302 and frame 304 is illustrated, in accordance with the principles of the present invention. FIG. 3A illustrates a perspective view of securing assembly 300. As shown in FIG. 3A, assembly 300 may include securing surface 302 and frame 304. Securing surface 302 may be secured to frame 304, and frame 304 may be secured to a tailgate of a vehicle.

Referring now to FIG. 3B, a perspective view of securing surface 302 is illustrated. Securing surface 302 may be dual-layered having first securing surface 306 and second securing surface 308. Similar to securing surface 100 and securing surface 202, securing surface 302 may be planar and rectangular in shape. First securing surface 306 may be parallel to second securing surface 308. It is understood that, similar to securing surface 202, there may be a vacant void or a material between first securing surface 306 and second securing surface 308. First securing surface 306 and second securing surface 308 therefore may or may not be contiguous. It is further understood that more than two securing surfaces may be incorporated into securing surface 302 (e.g., three securing surfaces).

Like securing surface 202, first securing surface 306 and second securing surface 308 may come together at the perimeter of the securing structure 302 to form a beveled edge 310. Beveled edge 310 may extend along at least two sides of securing surface 302. Beveled edge 310 may be advantageous because securing surface 302 may be secured to a tailgate of a vehicle such that the tailgate may open and close without interference from securing surface 302.

Referring now to FIG. 3C, frame 304 is illustrated in accordance with an illustrative embodiment. Frame 304 may include a securing portion 312 and a second securing portion 314. Securing portion 312 may secure frame 304 to a tailgate of a truck and second securing portion 314 may secure frame 304 to securing surface 302. Securing portion 312 may be substantially flat and may include securing slot 316. Securing slot 316 may be a slot or another longitudinal void extending through securing portion 312 capable of receiving a threaded bold or other well-known device. It is also understood that multiple slots 316 may be distributed about securing portion 312 to better secure securing surface 302 to a tailgate of a vehicle.

Second securing portion 314 may protrude perpendicularly from securing portion 312. Second securing portion 314 may also include long sides 318 and short sides 320. Long sides 318 may correspond to the edge of securing surface 302 spanning the width of a tailgate. Long sides 318 may include hole 322 that may receive a threaded bolt or other well-known securing device to secure long sides 318 to frame 304. It is also understood that multiple holes 322 may be distributed along long sides 318 to better secure frame 308 to securing surface 302.

Short sides 320 may correspond to the edge of securing surface 302 spanning the height of a tailgate. Short sides 320 may have edges 324 similar to beveled edges 310, such that short sides 320 may fit within the void sides of securing surface 302. Short sides 320 may also each include top latch 326. Top latch 326 may be rigidly attached to the top of short side 320 and may partially protrude into the internal space of frame 304. Securing surface 302 may be placed on top latch 326 when assembling securing surface 302 and frame 304. Each of short sides 320 may also include slot 328 such that the space between securing surface 302 and a tailgate of a vehicle remains at least partially open. It may be understood that multiple slots 328 may be provided.

Securing surface 302, as shown in FIG. 3D, may include multiple through-holes 330. Through-hole 330 may include first through hole 332 extending through first securing surface 306, and second through hole 334 extending through second securing surface 308. Second through-hole 334 may align with first through-hole 332. Through-hole 330 may include protrusion receiving area 336 which may be sized to receive a protrusion (e.g., pin or lock) extending from a shaft of a tool. Through-hole 330 may be sized and shaped to receive the shaft of the tool. Protrusion receiving area 336 may be oriented at a certain angle (e.g., 45 degrees) from the longitudinal axis of securing surface 302.

Securing surface 302 may also include multiple receiving channels 338. As shown in FIG. 3E, track 340 may be inserted into receiving channel 338. In one example, track 340 may be glued otherwise affixed to receiving channel 338. Track 340 and/or receiving channel 338 may include one or more threaded portions 342 to receive and engage a threaded portion of a tool. It is understood that track 340 and receiving channel 338 may be a single component and/or otherwise may be integrated.

Track 340 and receiving channel 338 may be sized to receive a keyed portion of the tool (e.g., a keyed portion extending from the shaft of the tool). Track 340 may be “T” shaped to permit the keyed portion of the tool to enter track 340 from an end of track 340 (e.g., track end 344), and slide linearly along track 340. However, track 340 may restrain movement in any other direction. It is understood that track 340 and/or receiving channel 338 may be any other shape designed to restrain a keyed portion of the tool (e.g., a circular shape).

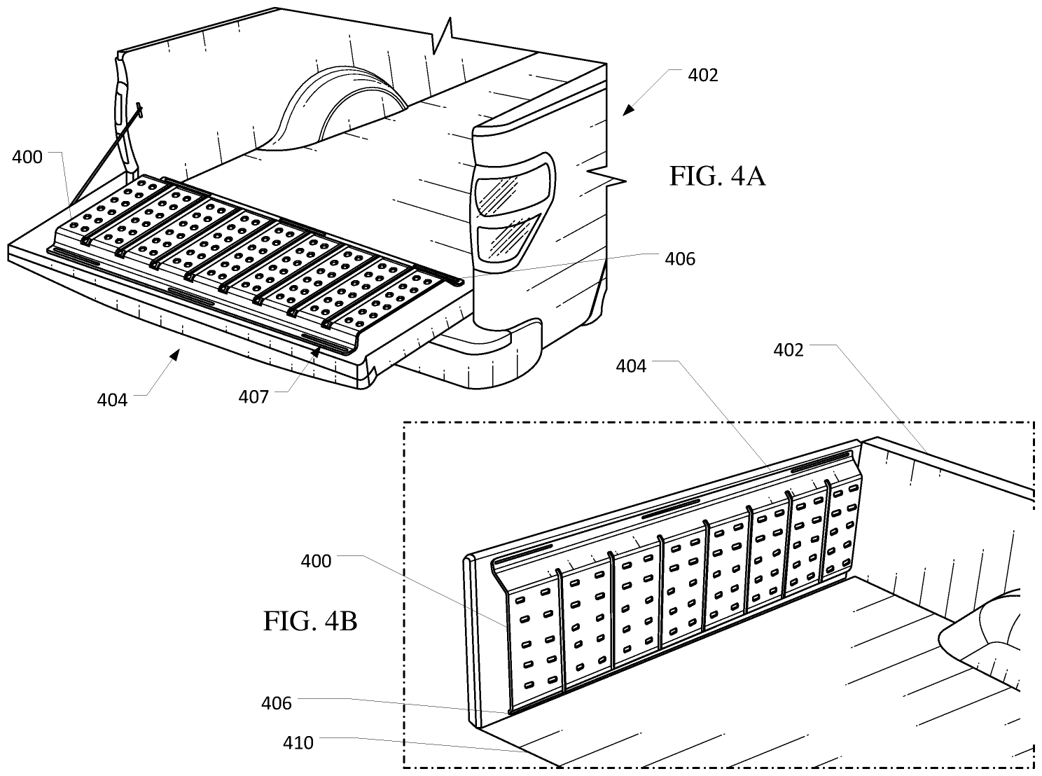

Referring now to FIGS. 4A-4B, a securing surface secured to a vehicle is depicted, in accordance with the principles of the present invention. As shown in FIG. 4A, securing surface 400 may be the same or similar to securing surface 202. Securing surface 400 may be secured to vehicle 402 via securing portions 407 that extend along the perimeter of securing surface 400. Specifically, securing portion 407 may be the same as securing portion 216 and may include a slot that receives a threaded engagement or other well-known engagement (e.g., bolt).

Securing portion 407 may be secured to a tailgate 404 of vehicle 402. Tailgate 404 may be a standard tailgate and may be transitioned from an open position illustrated in FIG. 4A to a closed position illustrated in FIG. 4B. Securing structure may include beveled edge 406 which may be the same as beveled edge 214. As shown in FIG. 4B, beveled edge 406 may permit securing structure to transition upward with tailgate 404 without interfering with vehicle 402. Specifically, beveled edge 406 may avoid interference of securing surface 200 with truck bed 410 and/or a similar surface of vehicle 402.

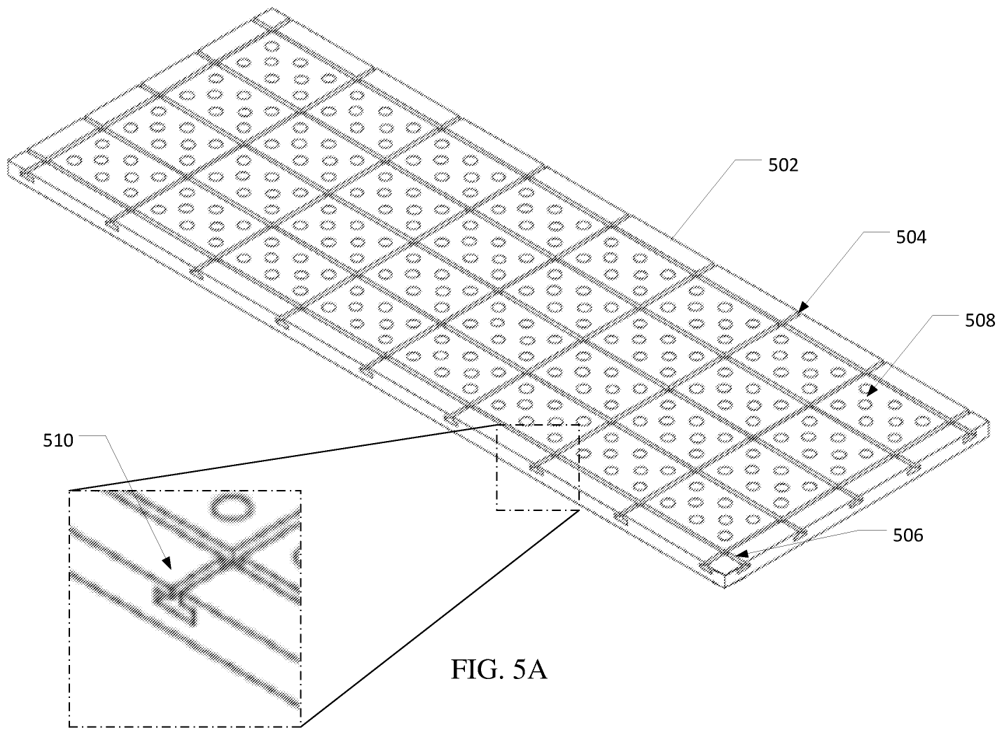

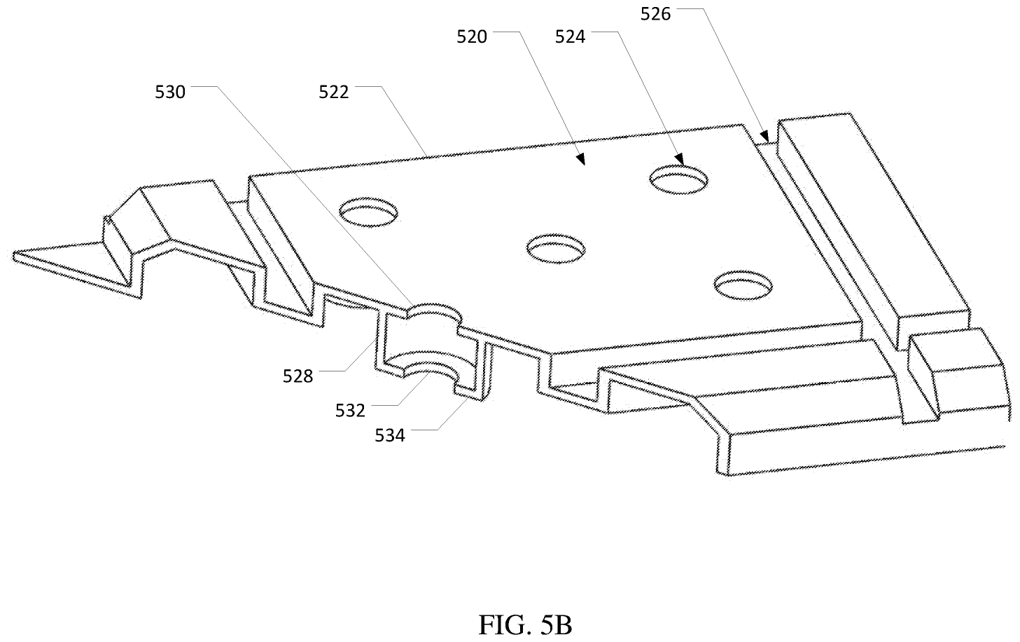

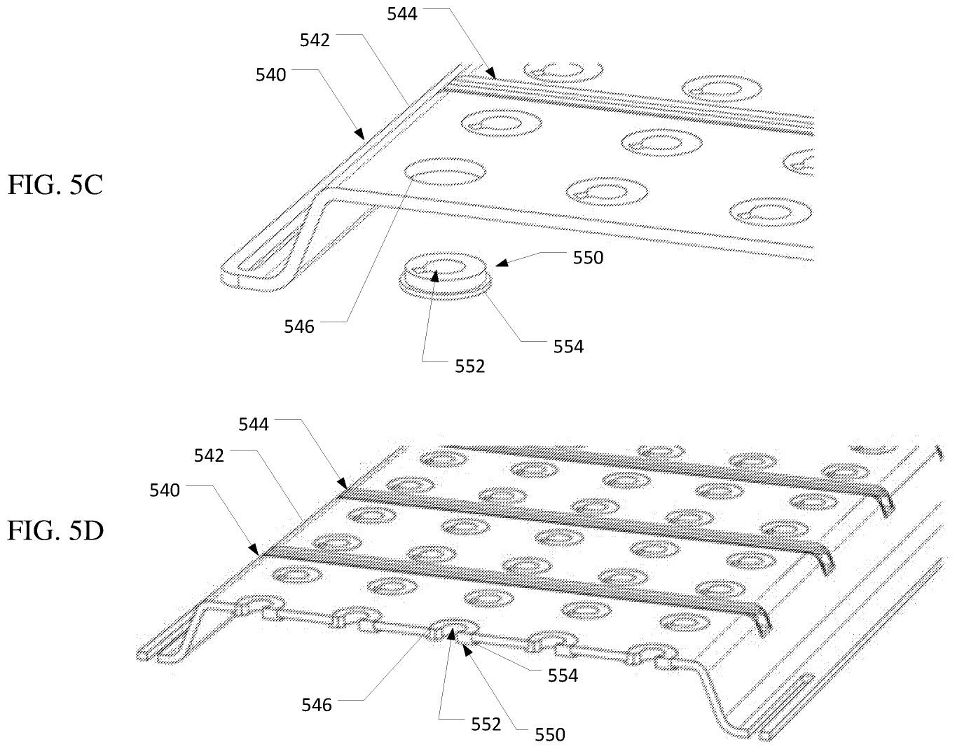

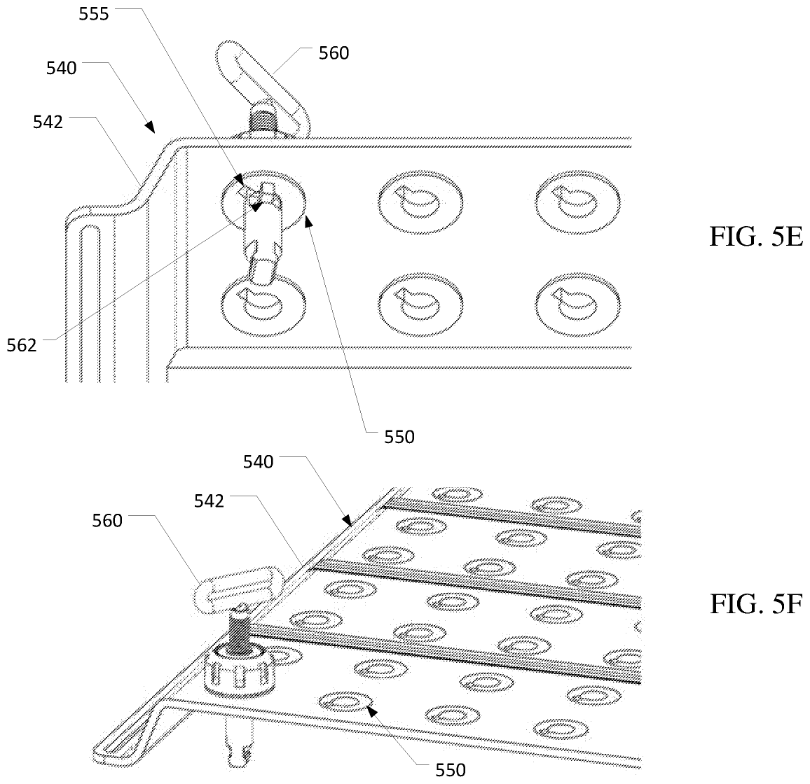

FIGS. 5A-5F illustrate alternative securing surfaces, in accordance with the principles of the present invention. Referring now to FIG. 5A, a securing surface 502 with through-holes 508 and receiving guides 504 and 506 arranged in multiple directions is depicted. Both horizontal receiving guides 504 and vertical receiving guides 506 may be incorporated into securing surface 502. Horizontal receiving guides 504 and vertical receiving guides 406 may be oriented perpendicular to one another. Securing surface 502 may further include a plurality of through-holes 508 arranged in a pattern.

As shown in FIG. 5A, securing surface 502 may be made from a single material and may extend from a first surface to a second surface. Alternatively, securing surface 502 may be hollow between the first surface and the second surface. Where securing surface 502 is a single material extending from a first surface to a second surface, through-holes 508 may include a middle second with a larger diameter than an opening at the first surface and the second surface. It is further understood that through-holes 508 may be circular, as shown in FIG. 5A, and/or may include a protrusion receiving area.

Horizontal receiving guides 504 and vertical receiving guides 506 may each include open ends 510 at the perimeter of securing surface 502 where a keyed portion of a tool may engage horizontal receiving guides 504 and vertical receiving guides 506. Open end 510 may be formed into a shape similar to a “T” shape such that the keyed portion may be retained from moving in any direction other than along horizontal receiving guides 504 and vertical receiving guides 506. It is understood that horizontal receiving guides 504 and vertical receiving guides 506 may not include a track disposed in the receiving guides.

Referring now to FIG. 5B, a cross-sectional view of alternative single layer securing surface is illustrated. Securing surface 520, which may have the same or similar shape as securing surface 202 of FIG. 2, may be a single layer that is molded or otherwise formed into the shape illustrated in FIG. 5B. Securing surface 520 may include first surface 522 and through-holes 524 extending through first surface 522. Securing surface 520 may further include receiving channels 526 which may be horizontal and/or vertical receiving channels. It is understood that receiving channels may be formed into securing surface 520. Receiving channels 526 may be similar to receiving channels 230 of FIG. 2B and/or may be combined with a track (e.g., track 236 of FIG. 2B).

Securing surface 520 may further include channel 528 which may extend from the bottom of first surface 522 of securing surface 520. Channel 528 may be cylindrical in shape and/or may be hollow. Channel 528 may align with first opening 530. Channel 528 may include second surface 534 and second opening 532 that is defined by second surface 534. Second surface 534 may parallel to first surface 522 and second opening 532 may be aligned with first opening 530 and/or may have the same size and/or shape (e.g., circular). Alternatively, first opening 530 may include a protrusion receiving area, whereas second opening 532 may not. It is understood that channel 528 may have a diameter bigger than first hole 430 and second hole 432 and further that channel 528 may accommodate a protrusion extending from a shaft of a tool.

Referring now to FIGS. 5C-D, another alternative single layer securing surface is illustrated. Securing surface 540 may be similar to securing surface 202 of FIG. 2, but may only include first securing surface 542, which may be similar to first securing surface 206 of FIG. 2. For example, first securing surface 542 may include through holes 546 that extend through first securing surface 542 and may further include receiving channels 544 that are formed into or otherwise defined by first securing surface 542.

Each through hole 546 may be sized and shaped to receive insert 550. Insert 550 may be cylindrical in shape and may include central passage 552 which may extend the length of insert 550. Central passage 552 may be cylindrical and may optionally include a protrusion receiving area. Insert 550 may further include lip 554 that ends circumferentially around a bottom end of insert 550 and may have a larger diameter than an outer diameter of the body of insert 550.

Insert 550 may be sized and shaped to fit through-hole 546 such that lip 554 has a diameter that is larger than a diameter of through-hole 546 and thus lip 554 may interface with a bottom surface securing surface 540. Insert 550 may be sized to friction fit with through-hole 546 and/or may be coupled to securing surface 540 via an adhesive. It is understood that insert 550 may be plastic, metallic and/or any other suitable rigid material. In one example, the height of insert 550 may be the same as the distance between first securing surface 206 and second securing surface 208 of FIG. 2.

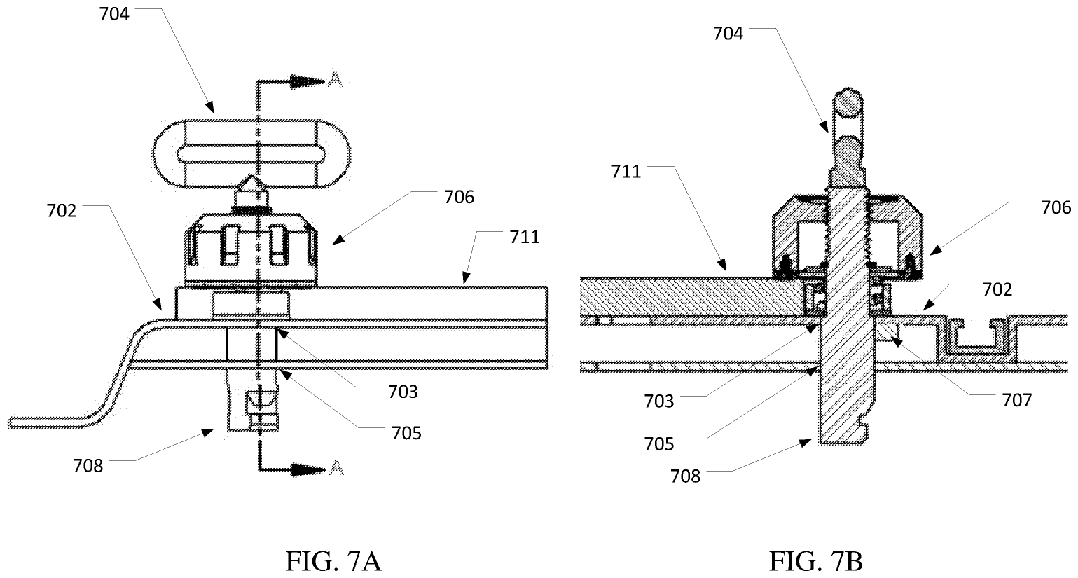

Referring now to FIGS. 5E-F, securing surface 540 including insert 550 is illustrated engaged with tool 560. It is understood that tool 560 may be the same or similar to tool 700 of FIGS. 7A-B. As shown in FIGS. 5E-F, tool 560 may traverse insert 550 such that a shaft of tool 560 extends beyond first securing surface 542. As shown in FIG. 5E, protrusion 562 which may extend from the shaft of tool 560 may be aligned with protrusion receiving area 555 of insert 550 as tool 560 extends through insert 550. Tool 560 may then be turned with respect to protrusion receiving area 555 to secure tool 550 to securing surface 540. While tool 560 is illustrated in FIGS. 5E-5F, it is understood that any other tools may employ a protrusion similar to protrusion 562 and thus may engage the securing surface in a similar manner.

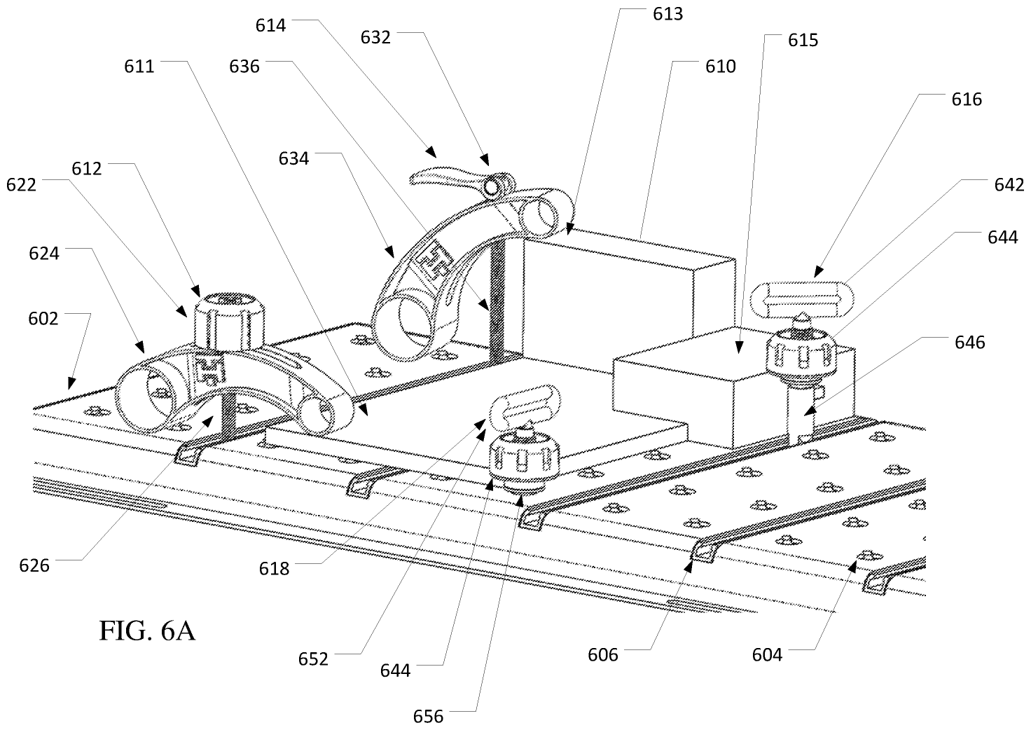

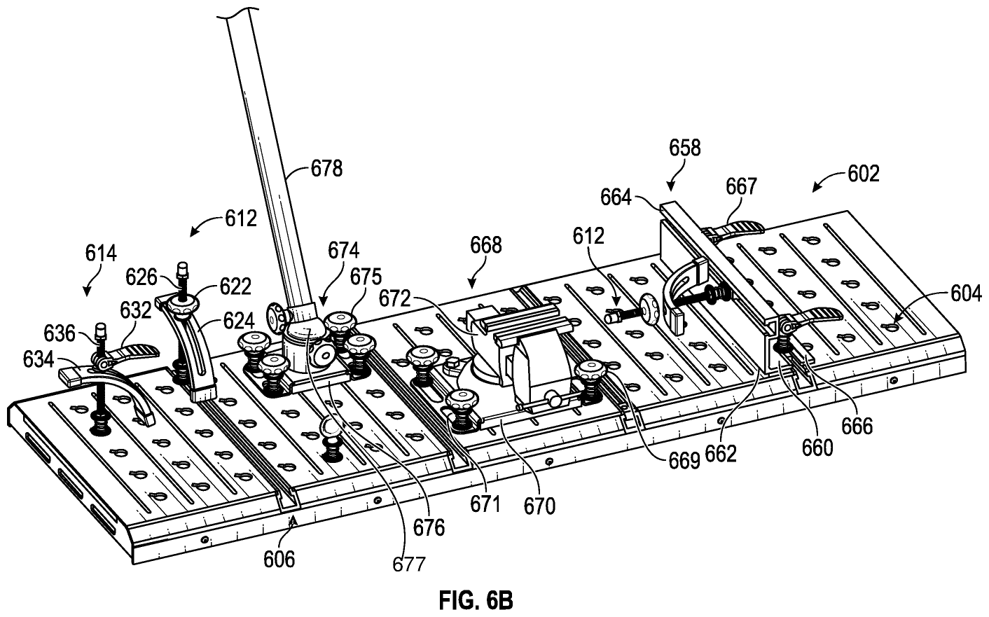

Referring now to FIG. 6A, multiple tools secured to the securing surface are illustrated, in accordance with the principles of the present invention. Securing surface 602 may be the same as securing surface 202 of FIG. 2, and may include through-holes 604, which may be the same as through-holes 204, as well as receiving channels 606, similar to receiving channel 205. As shown in FIG. 6, tools, 612, 614, 616 and 618 may be engaged with the securing surface and may restrain item 610, which may be a multi-faced structure, against securing surface 602.

Tool 612 may include knob 622, securing structure 624, and shaft 626 which may be threaded. Shaft 626 may be engaged with securing surface 602 at one end and knob 622 may be turned to secure securing structure 624 against securing surface 602 and surface 611 of item 610. Tool 614 may include lever 632, securing structure 634, and shaft 636 which may be threaded. Shaft 636 may be engaged with securing surface 602 at one end and lever 614 may be turned to secure securing structure 634 against securing surface 602 and surface 613 of item 610.

Tool 616 may include handle 642, knob 644, and shaft 646 which may include a keyed portion engaged with a receiving channel of securing surface 602. Handle 642 and/or knob 644 may be turned to cause knob 644 to engage surface 615 of item 610 to secure knob 644 against surface 615. Tool 618 may include handle 652, knob 654, and shaft 656 which may be engaged with a through-hole of securing surface 602. Handle 652 and/or knob 654 may be turned to cause knob 654 to engage surface 611 of item 610 to secure knob 654 against surface 611. In this manner, one or more tools may be engaged with securing surface 602 to secure one or more surfaces of a structure to securing surface 602.

Referring now to FIG. 6B, multiple tools secured to the securing surface are illustrated, in accordance with the principles of the present invention. Similar to FIG. 6A, tools 612, may be engaged with the securing surface. Tool 612 may include knob 622, securing structure 624, and shaft 626 which may be threaded. Shaft may be engaged with securing surface 602 at one end and knob 622 may be turned to secure securing structure 624 against securing surface 602 and a surface of an item. Tool 614 may include lever 632, securing structure 634, and shaft 636 which may be threaded. Shaft 636 may be engaged with securing surface 602 at one end and lever 614 may be turned to secure securing structure 634 against securing surface 602 and a surface of an item.

Fence 658 may also be secured to securing surface 602. Fence 658 may include securing side 660 and fencing side 662. Securing side 660 may include slots 666, which may receive tool 667. Tool 667 may traverse slots 666 and be secured within through holes 664, thereby securing fence 658 to securing surface 602. Fencing side 662 may be perpendicular to securing surface 602, and may include perpendicular channel 664. Perpendicular channel 664 may receive tool 612, or other tools or items, similar to receiving channel 606.

Large assembly 668 may also be secured to securing surface 602. Large assembly 668 may include plate 670, having slots 671. Tool 669 may be configured to secure plate 670 in through holes 604 via slots 671. Large assembly 668 may, for example, include vice 672. Small assembly 672 may similarly be secured to securing surface 602 with tools 675. Small assembly may include small plate 676, having ball joint 677. A tool or item having shaft 678 may extend from ball joint 677.

Referring now to FIGS. 7A-7B, a tool securing a structure to a securing surface is illustrated, in accordance with the principles of the present invention. As shown in FIG. 7A-7B, tool 704 may be engaged with securing structure 702, which may be the same as securing structure 202 of FIG. 2. Tool 704 may include knob 706 that may be threaded and engaged with shaft 708 of tool 704 such that knob 706 may traverse at least a portion of shaft 708. As shown in FIGS. 7A and 7B, shaft 708 may extend through through-holes 703 and 705 of securing surface 702. Knob 706 may secure item 711 to securing surface 702.

Referring now to FIG. 7B, protrusion 707 may extend from shaft 708. Upon inserting shaft 708 and protrusion 707 through through-hole 703 of securing surface 702, knob 706 may be turned to traverse a portion of shaft 708 to apply a force against item 711. As knob 706 is moved closer to protrusion 707, item 711 may be secured between securing structure 702 and knob 706, with protrusion 707 applying a resistance force against securing structure 702 as knob 706 is turned toward protrusion 707.

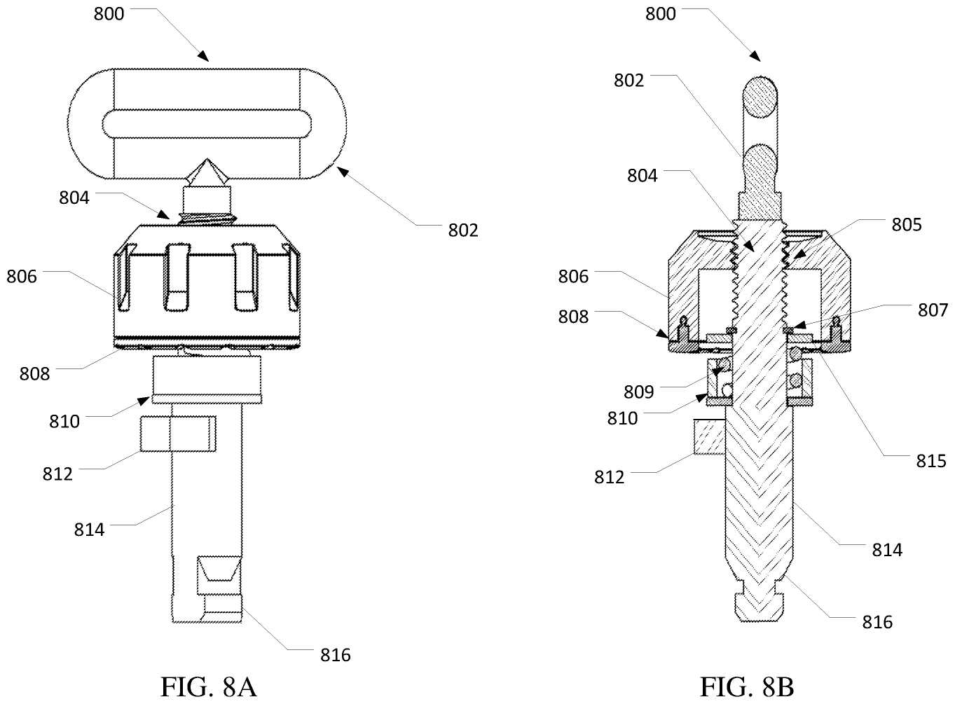

Referring now to FIGS. 8A-8B, a tool designed to be engaged with a receiving guide of a securing surface is illustrated, in accordance with the principles of the present invention. As shown in FIGS. 8A-8B, tool 800 may include handle 802 which may be rigidly coupled to or otherwise extend from shaft 814. Knob 806 may be engaged with shaft 814 via a threaded engagement. As shown in FIG. 8B, knob 806 may include threaded region 805 that is designed to engage threaded region 804 of shaft 814 that may extend a portion of shaft 814.

Knob 806 may further include contact surface 808 which may be disposed near the bottom of knob 806 and may be designed to make contact with one or more surfaces. In one example, contact surface 808 may be rubberized. Shaft 814 may include rigid protrusion 807 which may be disposed near the end of threaded region 805 and may prevent knob 806 from traversing shaft 814 beyond rigid protrusion 807. Knob 806 may further include surface 815 disposed near the bottom of knob 806 and designed to contact spring 809.

Shaft 814 may further include spring housing 810 which may be rigidly coupled to shaft 814 and may support spring 809 at one end of spring 809. Spring 809 may be disposed around shaft 814. As knob 806 traverses threaded portion 804 of shaft 814, surface 815 may contact spring 809 to apply a downward force against spring 809, thereby causing spring 809 to compress between surface 815 of knob 806 and spring housing 810. Spring 809 in a compressed state may then apply an upward force against knob 806.

Shaft 814 may also include protrusion 812 and keyed portion 816 at an end of shaft 814. Keyed portion 816 may be sized and shaped to engage with a receiving channel and/or track disposed in the receiving channel. For example, keyed portion 816 may be sized and shaped to be inserted in the receiving channel and/or track, such as a “T” shaped receiving channel and/or track. Keyed portion 816 may include angled edges to facilitate engagement with the receiving channel and/or track. It is understood that keyed portion 816 may be sized and shaped to engage with any shaped receiving channel and/or track, such as a circular shaped receiving portion and/or track.

While protrusion 812 may rigidly extend from shaft 814, it is understood that shaft 814 may alternatively include one or more protrusions (e.g., protrusion 812) that are coupled to shaft 814 via a spring connection such that protrusion 812 may extend from and retract into shaft 814. For example, protrusion 812 may be biased to extend from shaft 812 via the spring connection and may partially or fully retract into shaft 814. In one example, handle 802 and/or knob 806 may be in mechanical communication with protrusion 812 and rotational movement and/or axial displacement of handle 802 and/or knob 806 may cause protrusion 812 to move inward toward shaft 814, thereby retracting protrusion 812. Similar movement of handle 802 and/or knob 806 may cause protrusion 812 to release and/or extend from shaft 814. It is understood that protrusion 812 may have rounded edges and/or may be spherical or dome shaped.

As protrusion 812 may retract, shaft 814 may be inserted into through-holes that are circular and/or that do not include a protrusion receiving area. For example, as shown in FIG. 4, a securing surface may be similar to securing-surface 402 which may include through-holes 408 that are generally circular in shape. Protrusion 812 may be retracted and inserted into such through-holes. Alternatively, protrusions 812 may be caused to retract by the advancement of shaft 814 into through-hole 408. Protrusion 812 may then be biased via the spring connection to and/or may be caused to extend outward upon traversing a first layer of the securing surface.

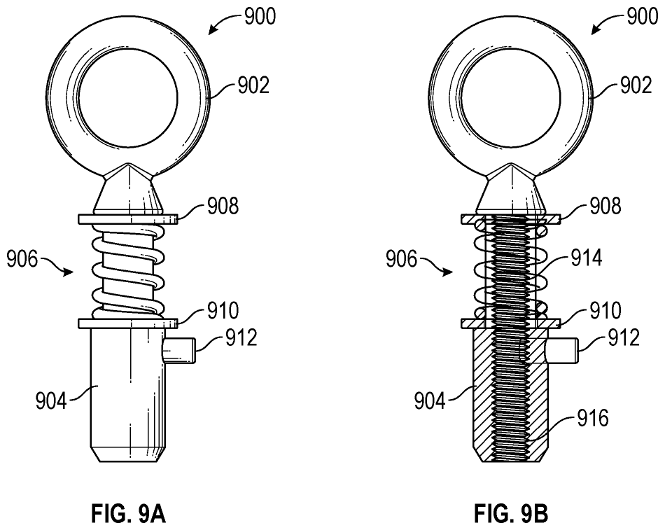

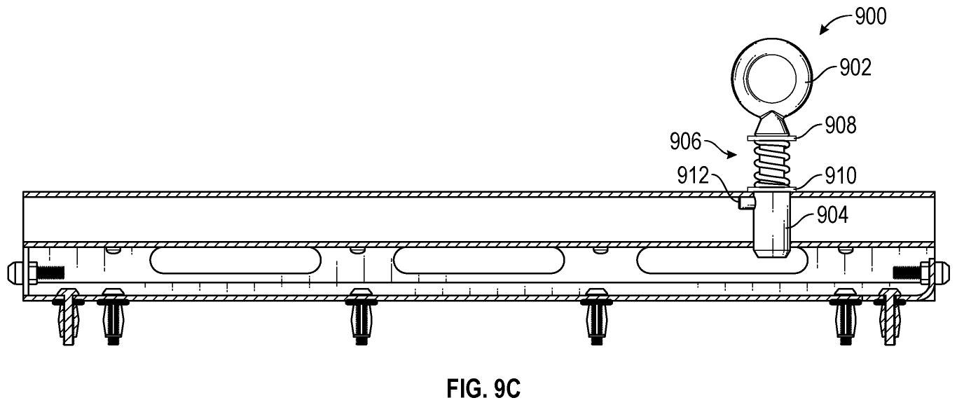

Referring now to FIGS. 9A-9C, a tool designed to be engaged with a receiving guide of a securing surface is illustrated, in accordance with the principles of the present invention. Tool 900 may include handle 902, which may be rigidly coupled to or otherwise extended from shaft 904. Alternatively, handle 902 may be engaged with shaft 904 via a threaded engagement. As shown in FIG. 9B, handle 902 may include a threaded region 914 that is designed to engage threaded region 916 of shaft 904 that may extend at least a portion of shaft 904.

Tool 900 may also include spring 906 which may be disposed about shaft 904. Spring 906 may be attached to top surface 908 and bottom surface 910 at another end. The distal portion of shaft 904 may be wider than the proximal portion of shaft 904 about which spring 906 is disposed. Bottom surface 910 may therefore contact the proximal portion of shaft 904. Top surface 908 contacts handle 902 to maintain the position of spring 906 about shaft 904. As handle 902 traverses threaded portion 916 of shaft 904, top surface 908 may also apply a downward force against spring 906 to compress spring 906 between top surface 908 and bottom surface 910. In a compressed state, spring 906 may apply an upward force against handle 902.

Shaft 904 may also include protrusion 912 rigidly extending from shaft 904. It is understood that protrusion 912 may have rounded edges and/or may be spherical or dome shaped. Because protrusion 912 is relatively fixed to shaft 904, shaft 904 may be inserted through only holes that include a protrusion receiving area. For example, to be inserted protrusion 912 of shaft 904 is aligned with a protrusion receiving area of a through-hole, such that protrusion 912 may traverse the through-hole. When shaft 904 is turned after protrusion 912 traverses the protrusion receiving area, protrusion 912 may be prevented from once again traversing the through-hole, and thus may be locked into the through-hole.

When shaft 904 is inserted into a through-hole, tool 900 may be stabilized within the through-hole. Referring to FIG. 9C, shaft 904 may be disposed within the through-holes of the first and second securing surfaces. Tool 900 may be turned so that protrusion 912 may be positioned below the first securing surface. When protrusion 912 is positioned below the first securing surface, protrusion 912 may be prevented from traversing the through-hole. Protrusion 912 may prevent vertical movement of tool 900. The distal end of shaft 904 may disposed within the through-hole such that shaft 904 may contact the through-hole. Shaft 904 may contact the through-hole such that the through-hole may prevent horizontal movement of tool 900. The securing surface therefore may prevent both vertical and horizontal movement of tool 900.

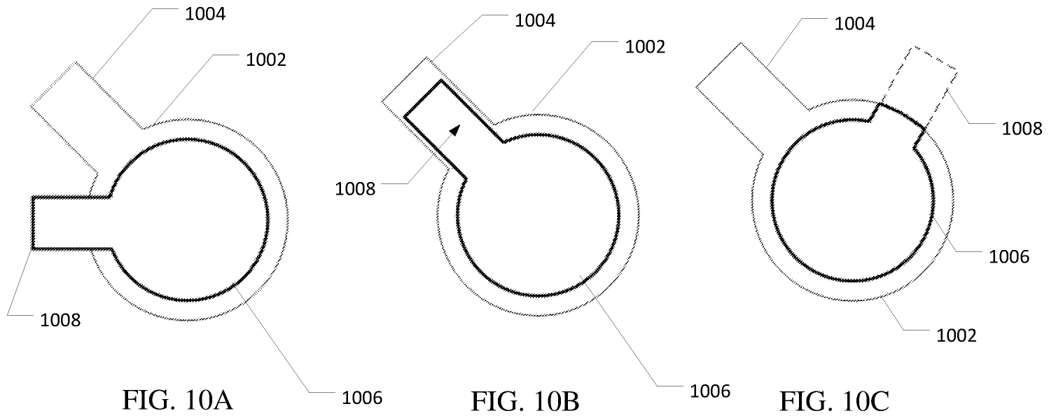

Referring now to FIGS. 10A-10C, a through-hole of a securing surface is illustrated, in accordance with the principles of the present invention. Referring to FIG. 10A, protrusion 1008 extending from a shaft of a tool is illustrated above through-hole 1002 of a securing surface. As is shown in FIG. 10A, protrusion 1008 of shaft 1006 may not be aligned with protrusion receiving area 1004 of through-hole 1002 and thus protrusion 1008 may be prevented from traversing through hole-hole 1002.

Referring now to FIG. 10B, when protrusion 1008 of shaft 1006 is turned to be aligned with protrusion receiving area 1004 of through-hole 1002, protrusion 1008 may traverse through-hole 1002. Referring now to FIG. 10C, when protrusion 1008 of shaft 1006 is turned after traversing protrusion receiving area 1004, protrusion 1008 may once again be prevented from traversing through-hole 1002, and thus may be locked into through hole 1002. As shown in FIGS. 10A-10C, through hole receiving area may be oriented 45 degrees from a central axis of a securing surface, similar to the through-hole orientation in FIG. 1. It is understood, that any other through-hole orientation may be employed.

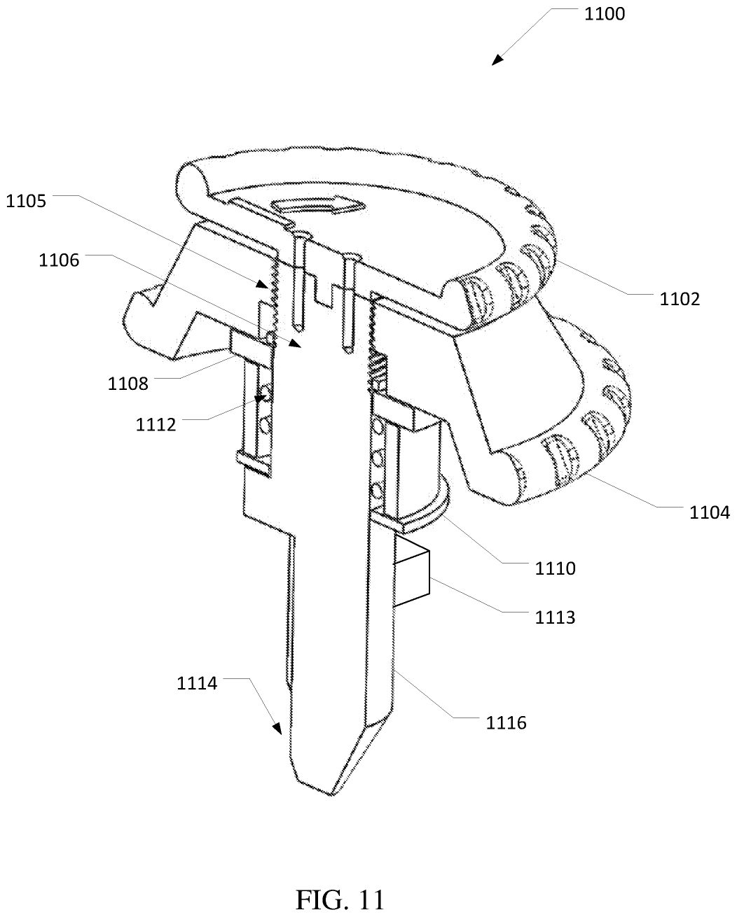

Referring now to FIG. 11, a tool including dual knobs is illustrated in accordance with the principles of the present invention. Tool 1100 may include knob 1102 which may be engaged with or otherwise coupled to shaft 1116. Shaft 1116 may include threaded portion 1106 which may extend a portion of shaft 1116. Knob 1104 may be disposed below knob 1102 and may include threaded portion 1105 that may engage with threaded portion 1106 to traverse shaft 1116. Surface 1108 may positioned around shaft 1116 and may move up and down shaft 1116 as knob 1104 moves up and down shaft 1116 with knob 1104.

Shaft 1116 may further include spring housing 1110 that may house spring 1112 which may be disposed around shaft 1116 and may be restrained at one end of spring 1112 by spring housing 1110. As knob moves down shaft 1116, surface 1108 may move down shaft 1116 and compress spring 1112 against spring housing 1110. It is understood that spring housing may then apply a spring force against surface 1108 and thus knob 1104. Shaft may optionally include protrusion 1113, which may be similar to protrusion 1112. Protrusion 1113 and spring housing 1110 may restrain tool 1100 against a securing surface.

As shown in FIG. 11, shaft 1116 may optionally include notch portion 1116 which may include an angular notch 1114. The angular notch 1114 may include a right angle. It is understood that the securing surface may have an angular notch receiving area that may be designed to engage angular notch 1114 such that angular notch 1114 may fit into the angular notch receiving area. The angular notch receiving area may prevent shaft 1116 from rotating within angular notch receiving area.

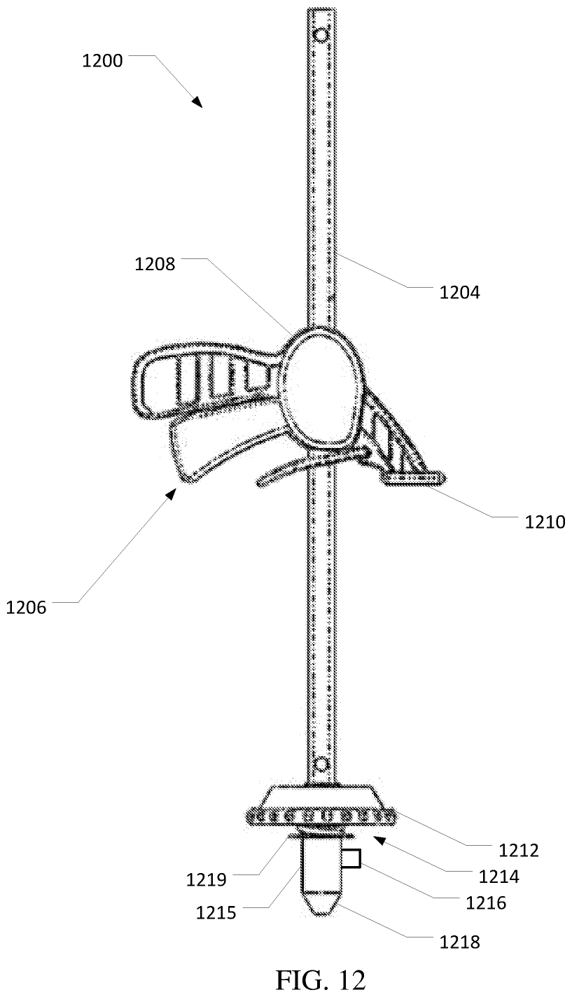

Referring now to FIG. 12, a clamping tool is illustrated in accordance with the principles of the present invention. Clamping tool 1200 may include shaft 1215 that may be rigidly connected to guide 1204. Handgrip 1206 may engage guide 1204 and may include handle portion 1208 and contact portion 1210. Handle portion 1208 may include a trigger to lock and unlock handgrip 1206 with respect to guide 1204. Contact portion 1210 may be intended to make contact with an item or structure.

Shaft 1215 may include a threaded portion engaged with knob 1212 which may also include a threaded portion and may traverse shaft 1215 along the threaded portion. Spring 1214 may be disposed around shaft 1215 and may be restrained at one end of spring 1214 by surface 1219 that may extend from shaft 1215 and may be compressed at another end of spring 1214 by knob 1212. Shaft 1215 may further include protrusion 1216. A distal end 1218 of shaft 1215 may be rounded such that shaft 1215 may be easily inserted into a through-hole of a securing structure.

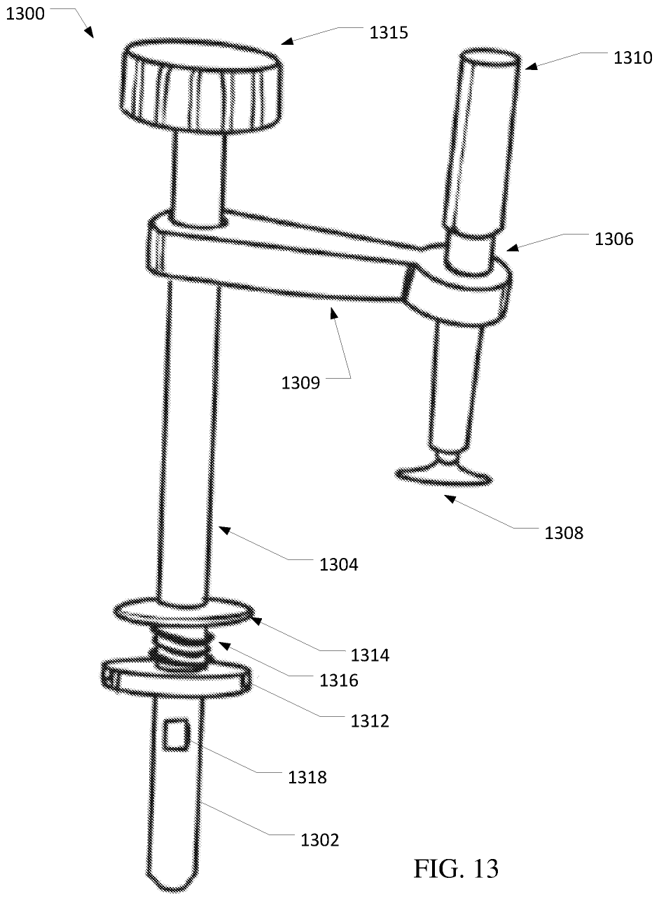

Referring now to FIG. 13, a compression tool is illustrated in accordance with the principles of the present invention. Tool 1300 may be designed to engage a securing surface and may include shaft 1302 that may be engaged with shaft 1304. For example, shaft 1302 and shaft 1304 may have a threaded engagement such that shaft 1304 may traverse shaft 1302. Shaft 1304 may be coupled to surface 1314 which may be designed to engage spring 1316 disposed around shaft 1304. Surface 1312 may similarly be coupled to shaft 1302 and may engage another end of spring 1116.

Knob 1315 may be turned to cause shaft 1304 to traverse shaft 1302 (e.g. via the threaded engagement). As shaft 1304 moves towards shaft 1302, spring 1316 may be compressed. Shaft 1302 may further include protrusion 1318, which may be similar to protrusion 712 of FIG. 7A. As shaft 1304 moves down, protrusion may provide resistance against the securing surface to secure tool 1300 to the securing surface.

Contact structure 1306 may extend from shaft 1304 via extension 1309 and may include contact surface 1308. Contact surface 1308 may be designed to engage an item or structure and secure the item or structure to the securing surface. Contact structure 1306 may optionally include threaded engagement with extension 1309 from shaft 1304 such that knob 1310 may permit further extension or retraction of contact surface 1308.

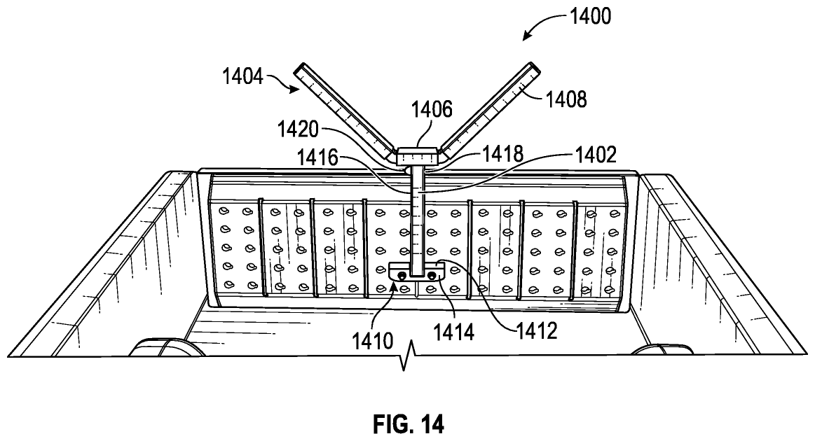

Referring now to FIG. 14, a vertical rack is illustrated in accordance with the principles of the present invention. Vertical rack 1400 may include a shaft 1402 and a rack portion 1404. Rack portion 1404 may rigidly extend from shaft 1402, such that rack portion 1404 may be centered on shaft 1402. Rack portion 1404 may have a base 1406 and arms 1408, where arms 1408 are rigidly or movably attached to either side of base 1406. Arms 1408 may extend from base 1406 at any angle between zero and ninety degrees. This extension angle may be fixed, or it may be adjustable to accommodate different objects that may be longer than a bed of a pickup truck. For example, arms 1408 may be adjusted to accommodate a kayak or lumber, both of which require different extension angles. The length of arms 1408 may also be fixed or adjustable.

Shaft 1402 may be coupled to mount 1410, where mount 1410 may engage with the securing surface. Mount 1410 may have a contacting surface 1412 and a non-contacting surface 1414. Contacting surface 1412 may have at least one threaded portion (not shown) configured to mate with, for example, threaded portion 916 of FIG. 9B to secure vertical rack 1400 to the securing surface with shaft 904. Contacting surface 1412 may be secured to the securing surface within the through holes, receiving channels, or both.

Non-contacting surface 1412 may attach to shaft 1402, such that shaft 1402 may be vertical (e.g., perpendicular to the ground) when a tailgate of a vehicle is closed. The length of shaft 1402 may be fixed or adjustable. Where the length of shaft 1402 is adjustable, shaft 1402 may include a first portion 1416 and a second portion 1418. First portion 1416 and second portion 1418 may be telescoping, where the first portion 1416 remains fixed to mount 1410 and second portion 1418 slides within first portion 1416 to change the overall length of shaft 1402. Shaft 1402 may also include knob 1420 to fix the position of first portion 1416 and second portion 1418 relative to one another.

Referring now to FIG. 15, a light source is illustrated in accordance with the principles of the present invention. Light 1500 may have base 1502 with threaded portion 1504. Threaded portion 1504 may mate with, for example, threaded portion 916 of FIG. 9B so that light 1500 may be securing to the securing surface by shaft 904. Light 1500 may be secured to the securing surface within the through holes, receiving channels, or both. As shown in FIG. 15, light 1500 may have flexible stem 1506 such that the position of light portion 1508 may be adjustable. It is understood that stem 1506 may be also be stiff, such that the position of light portion 1508 may be fixed. In some aspects, light portion 1508 may vary in size. In other aspects, light portion 1508 may vary in brightness. Light 1500 may be battery powered.

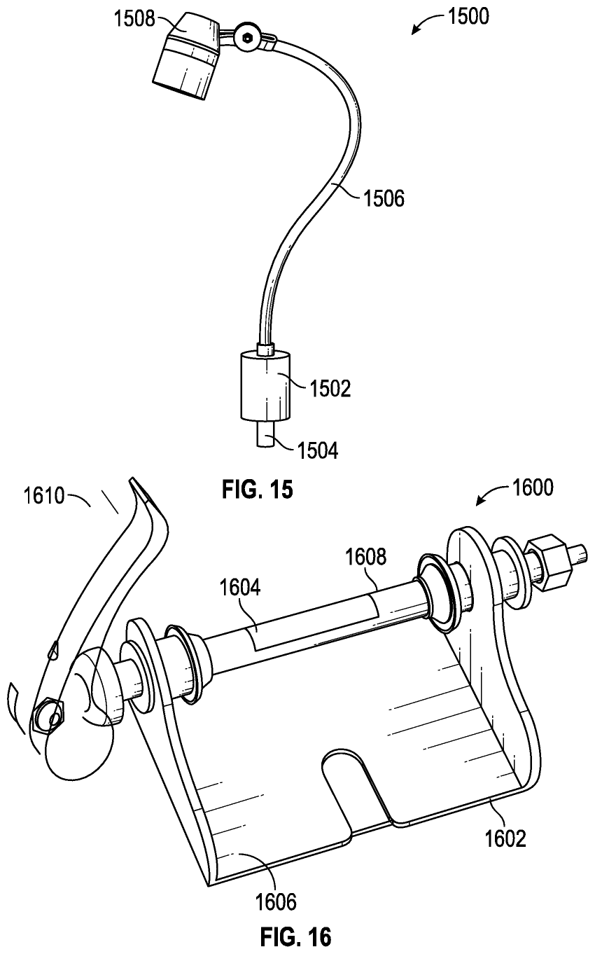

Referring now to FIG. 16, a swiveling bike mount is illustrated in accordance with the principles of the present invention. Bike mount 1600 may include base 1602 and mounting portion 1604, where base 1602 may engage the securing surface. Base 1602 may have threaded portion (not shown) that may mate with, for example, threaded portion 916 of FIG. 9B so that base 1602 may be securing to the securing surface by shaft 904. Base 1602 may be secured to the securing surface within the through holes, receiving channels, or both. Base 1602 may also include a rotating portion 1606. Rotating portion 1606 may rotate about base 1602 while base 1602 remains in a fixed position, secured in the securing surface.

The front wheel or forks of a bike may be secured to mounting portion 1604 when a bike is loaded into a bed of a pickup truck with the rear wheel first. In some aspects, mounting portion 1604 may include pin 1608 and lock 1610. As the tailgate is closed, rotating portion 1606 of base 1602 may swivel to continue to move the bike towards the back of the truck bed. As rotating portion 1606 moves, the bike may remain in the upright position. Affixing bike mount 1600 to the securing surface may greatly simplify and improve the ease of loading a bike into the bed of a pickup truck, which can often be cumbersome.

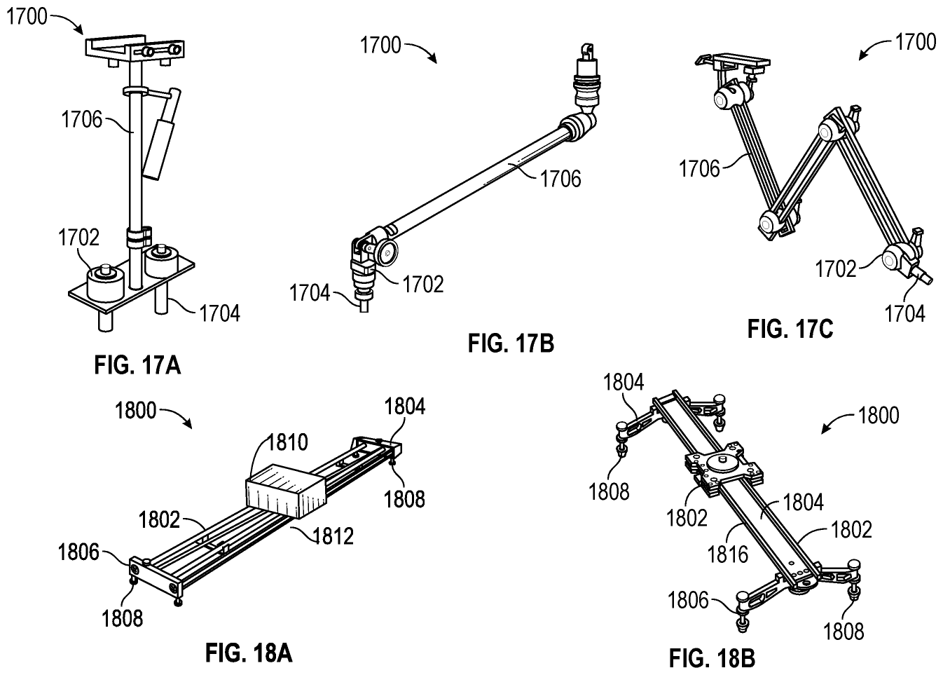

Referring now to FIGS. 17A-C, camera mounts are illustrated in accordance with the principles of the present invention. Camera mount 1700 may include a base 1702 that may engage the securing surface. Base 1702 may have threaded portion 1704 that may mate with, for example, threaded portion 916 of FIG. 9B so that base 1702 may be secured to the securing surface by shaft 904. Base 1702 may be secured to the securing surface within the through holes, receiving channels, or both. In some aspects, as shown in FIG. 17A, camera mount 1700 may have more than one base 1702. In other aspects, as shown in FIGS. 17B-C, camera mount 1700 may have only one base 1702.

Camera mount 1700 may also have shaft 1706 extending from base 1702. A camera may attach to the top of shaft 1706, according to known attachment means. In some aspects, as shown in FIG. 17A, shaft 1706 may extend vertically from the securing surface. In other aspects, as shown in FIG. 17B, shaft 1706 may extend from the securing surface at an angle. In either aspect, the length of shaft 1706 may be fixed or adjustable. In additional aspects, as shown in FIG. 17C, shaft 1706 may be segmented such that shaft 1706 may fold and expand to change the position of the camera.

Referring now to FIGS. 18A-B, camera tracks are illustrated in accordance with the principles of the present invention. Camera track 1800 may include track portion 1802 disposed between first securing portion 1804 and second securing portion 1806. Each of first securing portion 1804 and second securing portion 1806 may have at least one threaded portion 1808. Threaded portion 1808 may mate with, for example, threaded portion 916 of FIG. 9B so that first securing portion 1804 and second securing portion 1806 may be secured to the securing surface by shaft 904. First securing portion 1804 and second securing portion 1806 may be secured to the securing surface within the through holes, receiving channels, or both.

Camera track 1800 may also include mount 1810. Mount 1810 may be configured to hold a camera. In some aspects, as shown in FIG. 18A, camera track 1800 may include a plurality of rails 1812 along which mount 1810 may slide. In other aspects, as shown in FIG. 18B, camera track 1800 may have a plate 1814 and protrusions 1816 about which mount 1810 may slide. In either aspect, mount 1810 may be configured to lock in place when the camera is in the desired position. The position of mount 1810 may be controlled manually in some aspects or with a remote control in other aspects.

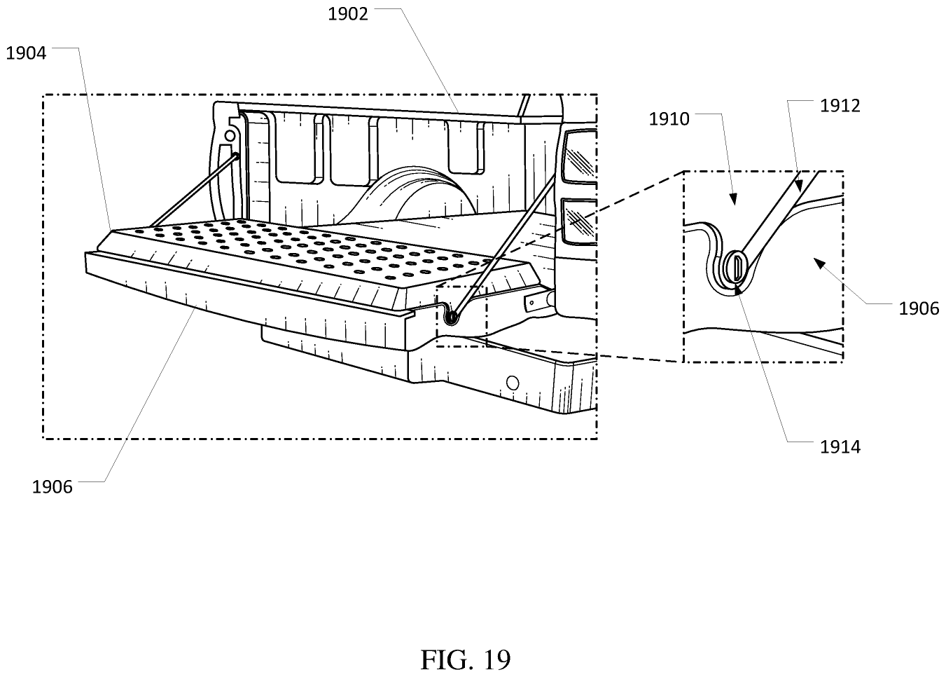

Referring now to FIG. 19, a securing surface with a native engagement is illustrated in accordance with the principles of the present invention. As is shown in FIG. 19, vehicle 1902 may include tailgate 1906 and securing surface 1904, which may be similar to securing surface 202 of FIG. 2, may be secured to tailgate 1906. Securing surface 1904 may include securing portion 1910 which may be an extension of a perimeter of securing surface 1904 and may extend to a native tailgate engagement (e.g., tailgate engagement 1914) and include a hole or slot aligned with the native tailgate engagement.

Tailgate engagement 1914 may be a screw and/or threaded type engagement. For example, tailgate 1906 may be restrained in movement by tailgate restraint 1912 which may connect to a tailgate via tailgate engagement 1914. Tailgate engagement 1914 may be temporarily removed and tailgate securing portion 1910 may extend over a threaded engagement of tailgate 1906. Tailgate engagement 1914 may then be reengaged with tailgate 1906 such that it now secures securing surface 1904 and tailgate restraint 1912 to tailgate 1906.

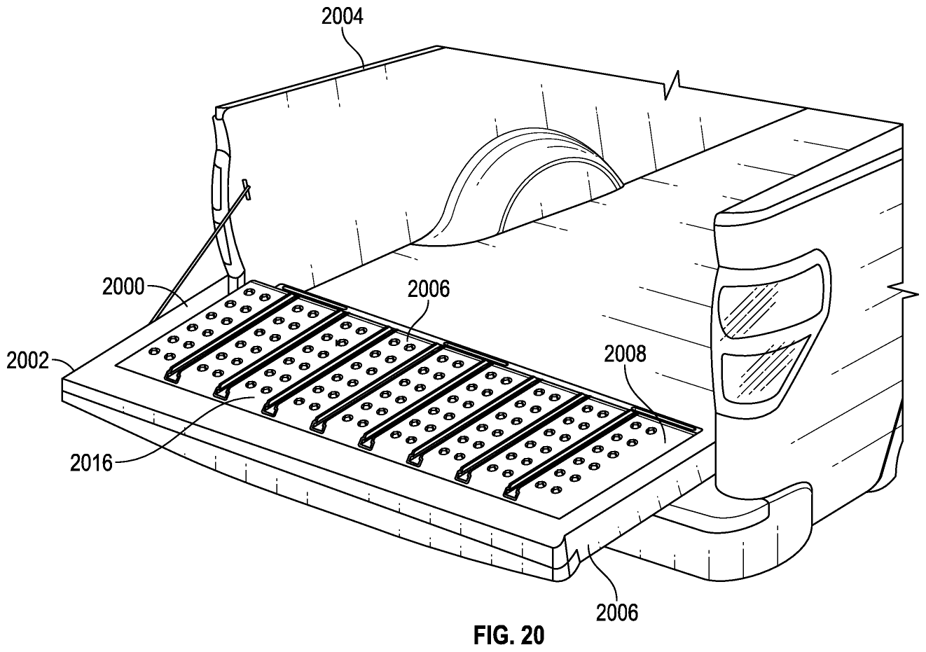

Referring now to FIG. 20, a securing surface that is integrated with a tailgate is illustrated in accordance with the principles of the present invention. Securing surface 2000 may be integrated into a tailgate 2002 of a vehicle 2004. Securing surface 2000 may be built into tailgate 2002 such that securing surface 2000 may be flush with side walls 2006 of tailgate 2002. Securing surface 2000 may have first securing surface 2006 and second securing surface 2008. First securing surface 2006 and second securing surface 2008 may come together to form beveled edge 2010. Beveled edge 2010 may extend along at least two sides of securing surface 2000 to prevent interference in closing tailgate 2002.

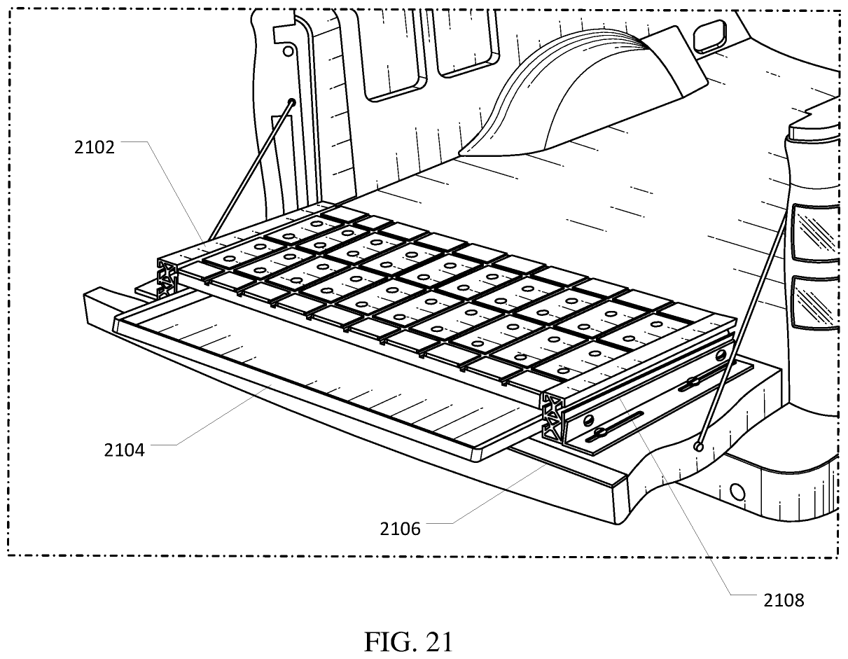

Referring now to FIG. 21, a securing surface with a container is illustrated in accordance with the principles of the present invention. As is shown in FIG. 21 securing surface 2102 may be secured to tailgate 2106. Securing surface 2102 may be similar to securing surface 100 of FIG. 1, but may include receiving channels in both vertical and horizontal directions. Securing surface 2102 may include supports 2108 that raise the first and second securing surface of securing surface 2102 above a surface of tailgate 2106, such that container 2104 may fit below the first and second securing surface of securing surface 2102.

Container 2104 may slide in and out of securing surface 2102 (e.g., using a wheel and rail system). It is understood that container 2104 may be sized and shaped to contain one or more tools designed to engage securing surface 2102. It is further understood that container 2104 may be one or more containers and/or may be connected to securing surface 2102 in any other well-known manner that facilitates accessing container 2104 from under securing surface 2102.

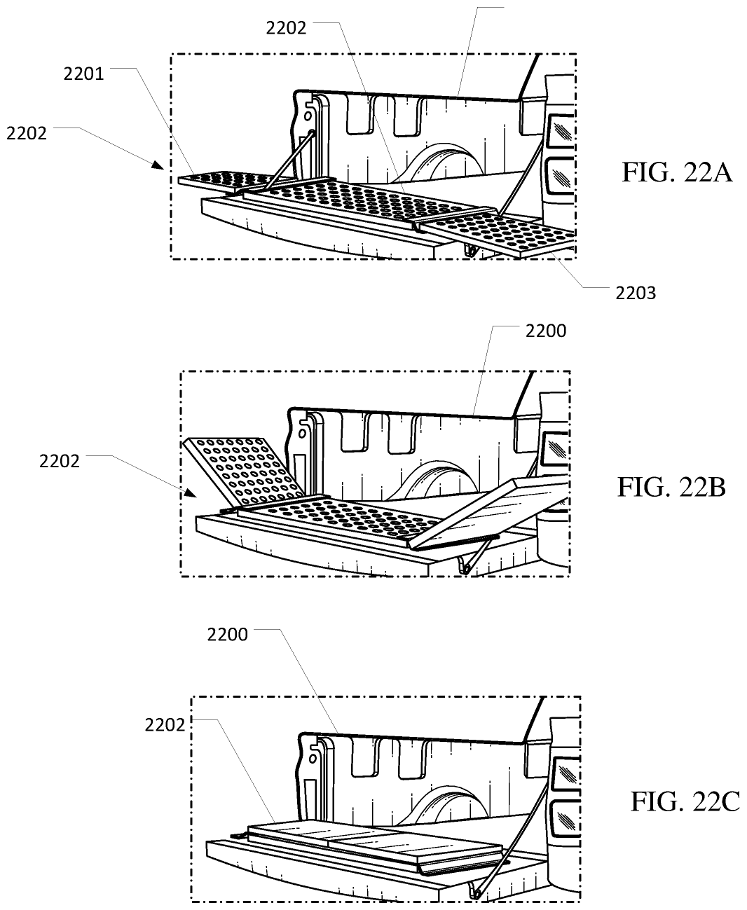

Referring now to FIGS. 22A-22C, a folding securing surface is illustrated in accordance with the principles of the present invention. As shown in FIG. 22A, securing portion 2202 may be secured to vehicle 2200 (e.g., at the tailgate). Securing surface 2202 may be similar to securing surface 202 of FIG. 2, but may include left portion 2201, middle portion 2202, and right portion 2203. Left portion 2201 and right portion 2203 may be connected to middle portion 2202 via a hinged connection and/or any other flexible joint.

As shown in FIGS. 22B-22C, left portion 2201 and right portion 2203 may fold upwards towards middle portion 2202 and fold on top of middle portion 2202 (e.g., for storage). It is understood that left portion 2201, middle portion 2202, and/or right portion 2203 may lock into place in the open position shown in FIG. 22A and/or the closed position shown in FIG. 22C. In this manner securing surface 2202 may be extended beyond the length of the tailgate and may be stowed for transportation.

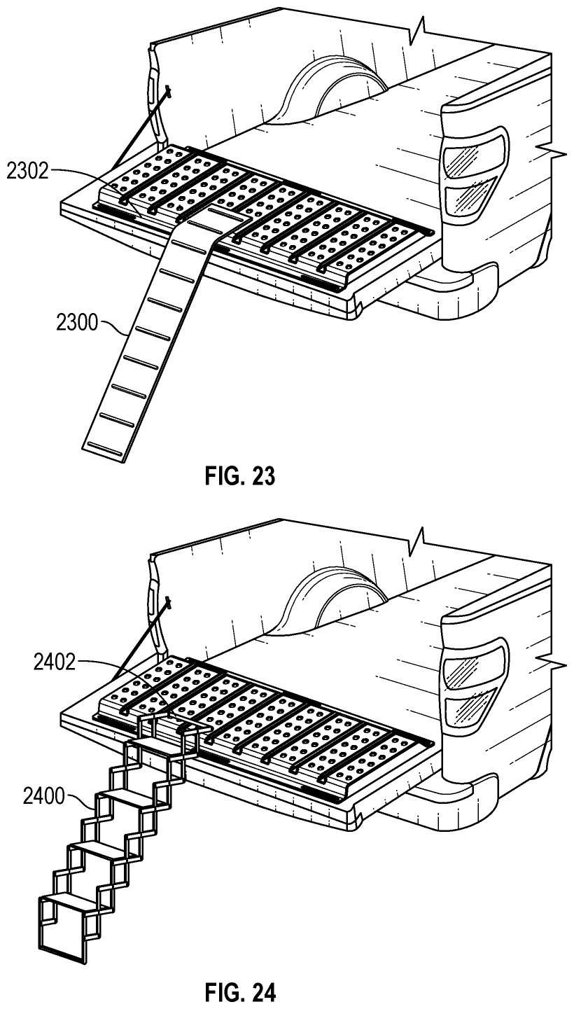

Referring now to FIG. 23, a ramp is illustrated in accordance with the principles of the present invention. Ramp 2300 may include mount 2302, which may have at least one threaded portion (not shown) that may mate with, for example, threaded portion 916 of FIG. 9B so that mount 2302 may be secured to the securing surface by shaft 904. In some aspects, mount 2302 may have at least one shaft (not shown) that may include a protrusion (not shown) rigidly extending from the shaft. The protrusion may be aligned with a protrusion receiving area of a through hole so that the protrusion may traverse the through hole. When the shaft is turned after the protrusion traverses the protrusion receiving area, the protrusion may be prevented from once again traversing the through hole and may be locked in place. Threaded portions or shafts may be arranged mirroring the through holes of the securing surface, so that ramp 2300 is aligned with the securing surface when secured.

Ramp 2300 may be secured to the front of the securing surface or either side of the securing surface. The width of ramp 2300 may also vary. In some aspects, as shown in FIG. 23, the width of ramp 2300 may be only part of that of the securing surface. In other aspects, the width of ramp 2300 may be the same as that of the securing surface. Ramp 2300 may have a fixed length, where this length must be at least long enough so that ramp 2300 contacts the ground. In other aspects, the length of ramp 2300 may be adjusted to adjust the angle of the ramp 2300.

Referring now to FIG. 24, steps are illustrated in accordance with the principles of the present invention. Steps 2400 may include mount 2402, which may have at least one threaded portion (not shown) that may mate with, for example, threaded portion 916 of FIG. 9B so that mount 2402 may be secured to the securing surface by shaft 904. In some aspects, mount 2402 may have at least one shaft (not shown) that may include a protrusion (not shown) rigidly extending from the shaft. The protrusion may be aligned with a protrusion receiving area of a through hole so that the protrusion may traverse the through hole. When the shaft is turned after the protrusion traverses the protrusion receiving area, the protrusion may be prevented from once again traversing the through hole and may be locked in place. Threaded portions or shafts may be arranged mirroring the through holes of the securing surface, so that steps 2400 is aligned with the securing surface when secured. Steps 2400 may be secured to the front of the securing surface or either side of the securing surface. In some aspects, as shown in FIG. 24, steps 2400 may be similar to a step ladder. In other aspects, steps 2400 may be similar to a ladder. In another aspect, steps 2400 may be a single step.

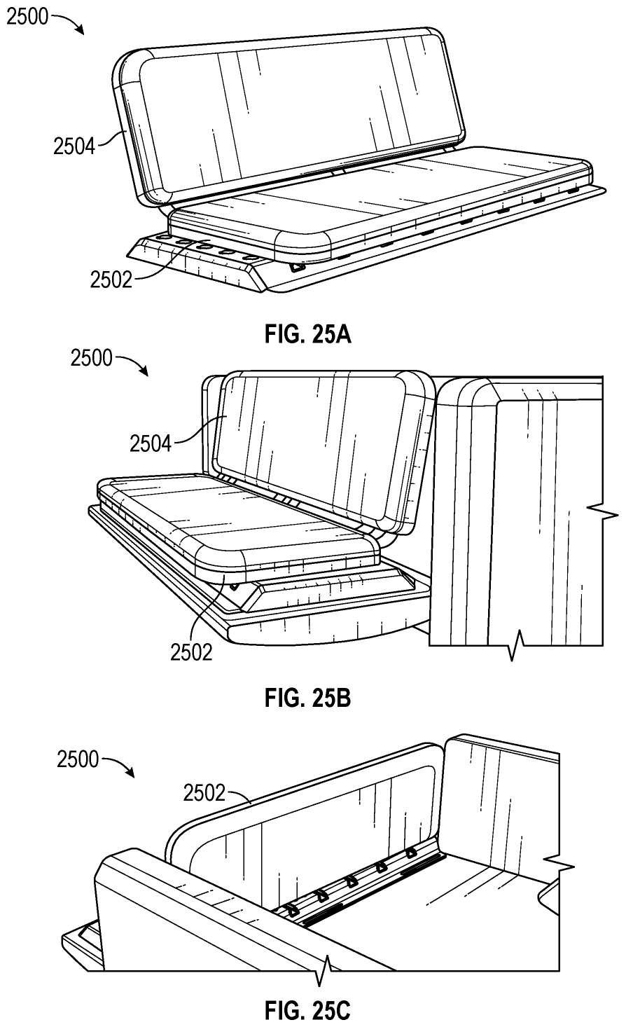

Referring now to FIGS. 25A-C, a seat is illustrated in accordance with the principles of the present invention. Seat 2500, as shown in FIG. 25A, may be secured on top of the securing surface. Seat 2500 may include base 2502 and back 2504, where base 2502 may attach to the securing surface. In some aspects, back 2504 may be fixedly attached to base 2502. In other aspects, back 2504 may be attached to base 2502 in a manner than enables movement of back 2504 relative to base 2502. As shown in FIGS. 25B-C, seat 2500 may be positioned on the securing surface so that back 2504 is aligned with the edge of the truck bed.

Base 2502 may have at least one threaded portion (not shown) that may mate with, for example, threaded portion 916 of FIG. 9B so that base 2502 may be secured to the securing surface by shaft 904. In some aspects, base 2502 may have at least one shaft (not shown) that may include a protrusion (not shown) rigidly extending from the shaft. The protrusion may be aligned with a protrusion receiving area of a through hole so that the protrusion may traverse the through hole. When the shaft is turned after the protrusion traverses the protrusion receiving area, the protrusion may be prevented from once again traversing the through hole and may be locked in place. Threaded portions or shafts may be arranged mirroring the through holes of the securing surface, so that seat 2500 is aligned with the securing surface when secured.

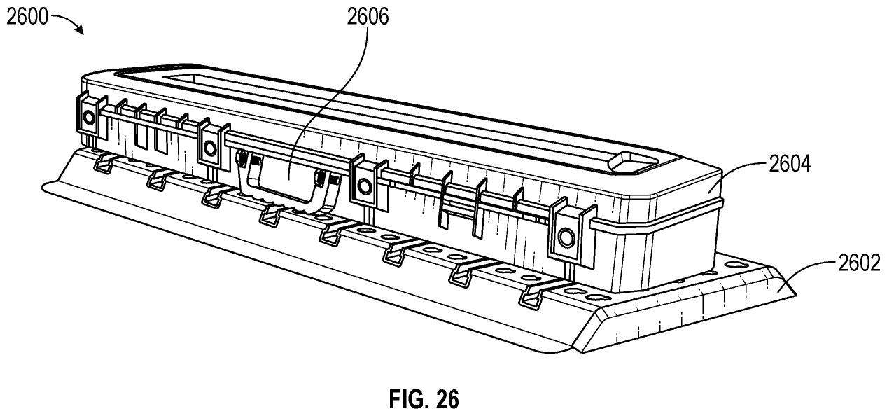

Referring now to FIG. 26, a storage locker is illustrated in accordance with the principles of the present invention. Locker 2600 may have body 2602 and lid 2604. Body 2602 and lid 2604 may be secured together with a hinge (not shown). Lid 2604 may rotate about the hinge between an open and a closed configuration. Locker 2600 may also have latch 2606 to secure lid 2604 to body 2602 when lid 2604 is in the closed configuration. In some aspects, locker 2600 may be a storage locker. In other aspects, locker 2600 may be configured to store firearms.

Body 2602 may have at least one threaded portion (not shown) that may mate with, for example, threaded portion 916 of FIG. 9B so that body 2602 may be secured to the securing surface by shaft 904. In some aspects, body 2602 may have at least one shaft (not shown) that may include a protrusion (not shown) rigidly extending from the shaft. The protrusion may be aligned with a protrusion receiving area of a through hole so that the protrusion may traverse the through hole. When the shaft is turned after the protrusion traverses the protrusion receiving area, the protrusion may be prevented from once again traversing the through hole and may be locked in place. Threaded portions or shafts may be arranged mirroring the through holes of the securing surface, so that locker 2600 is aligned with the securing surface when secured.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims.

What is claimed is:

1. A securing surface configured to secure a first tool and a second tool, the securing surface comprising:
a first surface comprising a plurality of first through-holes and a plurality of linear guides, each of the plurality of first through-holes comprising a shaft receiving area configured to receive a shaft extending from the first tool and a protrusion receiving area configured to receive a protrusion extending from the shaft of the first tool;
a second surface comprising a plurality of second through-holes, the second surface disposed below the first surface and offset from the first surface by a distance, each of the plurality of second through-holes configured to receive the shaft of the first tool and aligned with a respective first-through hole of the plurality of first through-holes, the second surface together with the first surface configured to restrict movement of the first tool;
a plurality of tracks disposed within and secured by the plurality of linear guides, each of the plurality of tracks configured to engage a keyed distal region of a shaft of a second tool such that each track of the plurality of tracks is configured to restrict movement of the second tool to one direction of freedom along a respective linear guide of the plurality of linear guides; and
wherein the first surface and the second surface merge on at least two sides of the securing surface to form at least two beveled edges of the securing surface.

2. The securing surface of claim 1, further comprising a frame configured to couple the securing surface to a first structure.

3. The securing surface of claim 2, wherein the first structure is a tailgate of a vehicle and the at least two beveled edges permit the tailgate to transition from an open position to a closed position.

4. The securing surface of claim 1, wherein the shaft receiving area of each plurality of first through-holes is oriented 45 degrees from a longitudinal axis of the securing surface.

5. The securing surface of claim 1, wherein the securing surface comprises a left securing surface portion, a right securing surface portion, and a middle securing surface portion, and the left securing surface portion and the right securing surface portion are coupled to the middle securing surface portion by a hinged connection.

6. The securing surface of claim 5, wherein the left securing surface portion and right securing surface portion fold onto the middle securing surface portion.

7. The securing surface of claim 1, further comprising a container configured to transition between a first position directly below the second securing surface and a second position below and at least partially offset from the second securing surface.

8. The securing surface of claim 1, further comprising a securing portion extending from the at least two beveled edges, the securing portion configured to extend over a native engagement of the tailgate and configured to securely engage the native engagement of the tailgate.

9. The securing surface of claim 1, wherein the first surface further comprises second plurality of linear guides, the second plurality of linear guides oriented perpendicular to the plurality of linear guides.

10. The securing surface of claim 1, further comprising a core material disposed between the first surface and the second surface.

11. A system comprising:
a first tool comprising:
a shaft having a threaded passage and a protrusion;
a knob having a threaded portion, the threaded portion engaged with the threaded passage of the shaft; and
a spring disposed around a portion of the shaft, the spring configured to apply a spring force to the knob; and
a securing surface comprising:
a first surface having a plurality of first through-holes, each of the plurality of first through-holes having a shaft receiving area configured to receive the shaft of the first tool and a protrusion receiving area configured to receive the protrusion of the first tool;
a second surface comprising a plurality of second through-holes, the second surface disposed below the first surface and offset from the first surface by a distance, each of the plurality of second through-holes configured to receive the shaft of the first tool;
wherein the securing surface is configured to secure the first tool to the securing surface when the shaft of the first tool is disposed within a first through-hole of the plurality of first through-holes and a second through-hole of the plurality of second through-holes and the protrusion of the first tool is positioned between the first through-hole and the second through-hole and is angularly offset from a first protrusion receiving area of the first through-hole.

12. The system of claim 11, wherein the first surface and the second surface merge on at least two sides of the securing surface to form at least two beveled edges of the securing surface.

13. The system of claim 12, wherein a securing portion extends from the at least two beveled edges and is configured to couple the securing surface to a first structure.

14. The securing surface of claim 13, wherein the first structure is a tailgate of a vehicle and the at least two beveled edges permit the tailgate to transition from an open position to a closed position.

15. The system of claim 11, wherein the shaft receiving area of each plurality of first through-holes is oriented 45 degrees from a longitudinal axis of the securing surface.

16. The system of claim 11, wherein the first tool further comprising a handle rigidly coupled to the shaft.

17. The system of claim 11, wherein the first surface further comprises a first plurality of linear guides.

18. The system of claim 17, wherein the first surface further comprises a second plurality of guides, the second plurality of linear guides oriented perpendicular to the first plurality of linear guides.

19. The system of claim 17, wherein the distal portion of the shaft of the first tool comprises a “T” shape and is sized and shaped to engage one of the first plurality of linear guides.

20. The system of claim 11, wherein the knob further comprises a rubberized contact surface at the distal end of the knob.
